(19) United States
(12) Patent Application Publication
(10) Pub. No.: US 2021/0271508 A1
(43) Pub. Date: Sep. 2, 2021

(54) ELECTRONIC DEVICE FOR PROVIDING TRANSACTION INFORMATION AND OPERATING METHOD THEREOF

(71) Applicant: Samsung Electronics Co., Ltd., Suwon-si (KR)

(72) Inventors: Youna LEE, Suwon-si (KR); Dohyun JO, Suwon-si (KR); Sungjin PARK, Suwon-si (KR); Seongmin JE, Suwon-si (KR); Gyuhyun SHIN, Suwon-si (KR); Seungmin HA, Suwon-si (KR)

(21) Appl. No.: 17/189,722

(22) Filed: Mar. 2, 2021

(30) Foreign Application Priority Data
Mar. 2, 2020 (KR) 10-2020-0026118

(51) Int. Cl. G06F 9/46; G06F 9/38; G06F 9/34; H04L 9/06

(52) U.S. Cl. CPC G06F 9/467; G06F 9/3836; H04L 2209/38; H04L 9/0643; G06F 9/34

(57) ABSTRACT

An electronic device is provided. The electronic device includes a display, a memory storing instructions, and a processor operatively connected to the display and the memory, and the processor may be configured to execute the instructions so as to further cause the electronic device to if data provided in a predetermined format is recorded in a memory, identify validity of a first block chain address indicated by the data, if the validity of the first block chain address is identified, identify at least one second block chain address capable of performing a transaction with the first block chain address among at least one block chain address of a user of the electronic device, and display, on the display, a user interface including the first block chain address and the at least one second block chain address.

### CROSS-REFERENCE TO RELATED APPLICATION(S)

This application is based on and claims priority under 35 U.S.C. § 119(a) of a Korean patent application number 10-2020-0026118, filed on Mar. 2, 2020, in the Korean Intellectual Property Office, the disclosure of which is incorporated by reference herein in its entirety.

### BACKGROUND

### 1. Field

The disclosure relates to an electronic device which provides transaction information and an operation method thereof.

### 2. Description of Related Art

A decentralized network is a network that is different from a centralized network in which a central server makes a decision. The decentralized network refers to a network that performs decision making according to a consensus algorithm of nodes that join the decentralized network.

A distributed ledger refers to a ledger, which records transaction histories and is spread across several nodes when being stored.

A distributed ledger in a decentralized network may be stored in each of the nodes that join the decentralized network. The distributed ledger in the decentralized network may be updated according to a consensus algorithm of the nodes that join the decentralized network.

Therefore, a decentralized network having a distributed ledger may not need a centralized network, which is an advantage. Accordingly, a desire for various solutions using a decentralized network having a distributed ledger is increasing.

The above information is presented as background information only to assist with an understanding of the disclosure. No determination has been made, and no assertion is made, as to whether any of the above might be applicable as prior art with regard to the disclosure.

### SUMMARY

Various data may be recorded in a transaction transmitted from an electronic device to a decentralized network. The various data recorded in the transaction may include information associated with a reception side account (or reception side address) and a transmission side account (or a transmission side address).

Since the reception side account or the transmission side account may not include information associated with an account, if assets (e.g., coins, tokens (fungible tokens or non-fungible token (i.e., items)) are transmitted to an invalid reception side account, the assets may be evaporated without a benefit in return from the reception side account, which is a problem. In addition, if assets that a reception side does not require are transmitted to the reception side account, an appropriate benefit in return may not be obtained from the reception side account, which is also a problem.

The technical subjects pursued in the disclosure may not be limited to the above mentioned technical subjects, and other technical subjects which are not mentioned may be clearly understood, through the following descriptions, by those skilled in the art to which the disclosure pertains.

Aspects of the disclosure are to address at least the above-mentioned problems and/or disadvantages and to provide at least the advantages described below. Accordingly, an aspect of the disclosure is to provide an electronic device for providing transaction information and operating method thereof.

Additional aspects will be set forth in part in the description which follows and, in part, will be apparent from the description, or may be learned by practice of the presented embodiments.

In accordance with an aspect of the disclosure, an electronic device is provided. The electronic device includes a display, a memory storing instructions, and a processor operatively connected to the display and the memory, and the processor is configured to execute the instructions so as to cause the electronic device to if data provided in a predetermined format is recorded in the memory, identify validity of a first block chain address indicated by the data, if the validity of the first block chain address is identified, identify at least one second block chain address capable of performing a transaction with the first block chain address among at least one block chain address of a user of the electronic device, and display, on the display, a user interface including the first block chain address and the at least one second block chain address.

In accordance with another aspect of the disclosure, an operation method of an electronic device is provided. The operation method includes if data provided in a predetermined format is recorded in a memory of the electronic device, identifying validity of a first block chain address indicated by the data, identifying at least one second block chain address that is capable of performing a transaction with the first block chain address from among at least one block chain address of a user of the electronic device in response to a fact that the validity of the first block chain address is identified, and displaying a user interface including the first block chain address and the at least one second block chain address on a display of the electronic device.

According to various embodiments, an electronic device that provides transaction information and an operation method thereof may identify a transaction history of a reception side account and may recommend a transmission side account.

According to various embodiments, an electronic device that provides transaction information and an operation method thereof may identify a transaction history of a reception side account, and may recommend a transmission side account that holds assets, which are available for a transaction with the reception side account, among a plurality of transmission side accounts.

Other aspects, advantages, and salient features of the disclosure become apparent to those skilled in the art from the following detailed description, which taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device in a network environment according to an embodiment of the disclosure;

FIG. 2 is a diagram illustrating the configuration of an electronic device according to an embodiment of the disclosure;

FIG. 3 is a diagram illustrating an example of recording data provided in a predetermined format by an electronic device according to an embodiment of the disclosure;

FIG. 4 is a diagram illustrating an example of a transaction between a user account and a counterpart account according to embodiment of the disclosure;

FIG. 5A is a diagram illustrating an example of a screen of an electronic device which recommends user accounts according to an embodiment of the disclosure;

FIG. 5B is a diagram illustrating an example of a screen of an electronic device which recommends user accounts according to an embodiment of the disclosure;

FIG. 5C is a diagram illustrating an example of a screen of an electronic device which recommends user accounts according to an embodiment of the disclosure;

FIG. 5D is a diagram illustrating an example of a screen of an electronic device which recommends user accounts according to an embodiment of the disclosure;

FIG. 5E is a diagram illustrating an example of a screen of an electronic device which recommends user accounts according to an embodiment of the disclosure;

FIG. 5F is a diagram illustrating an example of a screen of an electronic device which recommends user accounts according to an embodiment of the disclosure;

FIG. 6A is a flowchart illustrating an operation of identifying validity of recorded data by an electronic device according to an embodiment of the disclosure;

FIG. 6B is a flowchart illustrating an operation of statically identifying validity of recorded data by an electronic device according to an embodiment of the disclosure;

FIG. 6C is a flowchart illustrating an operation of dynamically identifying validity of recorded data by an electronic device according to an embodiment of the disclosure;

FIG. 6D is a flowchart illustrating an operation of identifying validity of recorded data using a server by an electronic device according to an embodiment of the disclosure;

FIG. 6E is a flowchart illustrating an operation of receiving information associated with a recommended user account from a server, by an electronic device according to an embodiment of the disclosure;

FIG. 7 is a flowchart illustrating an operation of executing a wallet application corresponding to an account included in data, by an electronic device according to an embodiment of the disclosure;

FIG. 8 is a flowchart illustrating an operation of generating a transaction by an electronic device according to an embodiment of the disclosure;

FIG. 9 is a flowchart illustrating operation of an electronic device according to an embodiment of the disclosure; and

FIG. 10 is a flowchart illustrating operation of an electronic device according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

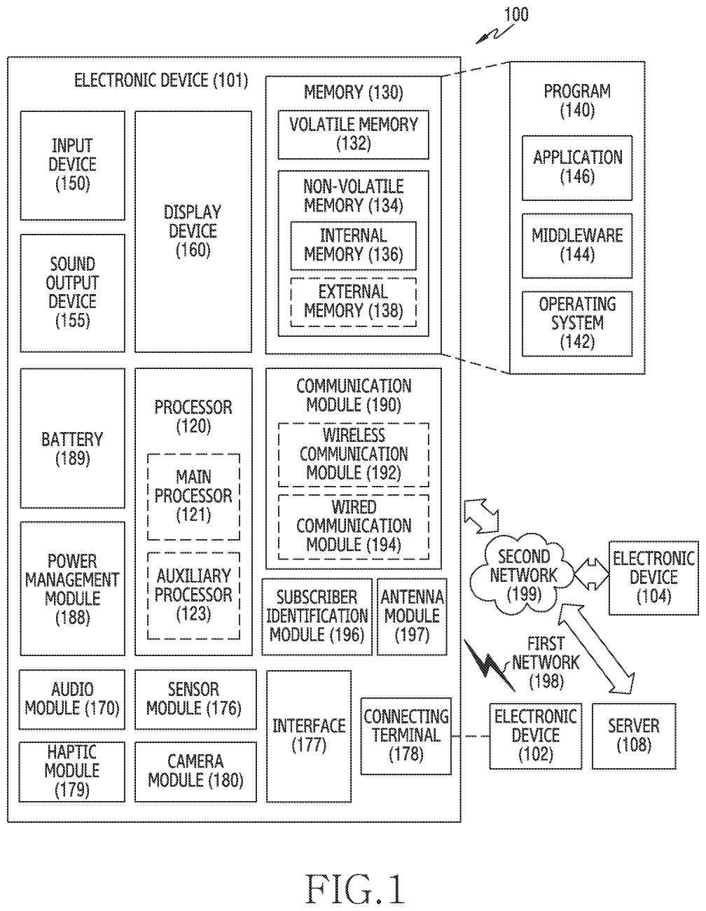

FIG. 1 is a block diagram illustrating an electronic device in a network environment according to an embodiment of the disclosure.

Referring to FIG. 1, an electronic device 101 in a network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input device 150, a sound output device 155, a display device 160, an audio module 170, a sensor module 176, an interface 177, a haptic module 179, a camera module 180, a power management module 188, a battery 189, a communication module 190, a subscriber identification module (SIM) 196, or an antenna module 197. In some embodiments, at least one (e.g., the display device 160 or the camera module 180) of the components may be omitted from the electronic device 101, or one or more other components may be added in the electronic device 101. In some embodiments, some of the components may be implemented as single integrated circuitry. For example, the sensor module 176 (e.g., a fingerprint sensor, an iris sensor, or an illuminance sensor) may be implemented as embedded in the display device 160 (e.g., a display).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may load a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display device 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input device 150 may receive a command or data to be used by other component (e.g., the processor 120) of the electronic device 101, from the outside (e.g., a user) of the electronic device 101. The input device 150 may include, for example, a microphone, a mouse, a keyboard, or a digital pen (e.g., a stylus pen).

The sound output device 155 may output sound signals to the outside of the electronic device 101. The sound output device 155 may include, for example, a speaker or a receiver. The speaker may be used for general purposes, such as playing multimedia or playing record, and the receiver may be used for an incoming calls. According to an embodiment, the receiver may be implemented as separate from, or as part of the speaker.

The display device 160 may visually provide information to the outside (e.g., a user) of the electronic device 101. The display device 160 may include, for example, a display, a hologram device, or a projector and control circuitry to control a corresponding one of the display, hologram device, and projector. According to an embodiment, the display device 160 may include touch circuitry adapted to detect a touch, or sensor circuitry (e.g., a pressure sensor) adapted to measure the intensity of force incurred by the touch.

The audio module 170 may convert a sound into an electrical signal and vice versa. According to an embodiment, the audio module 170 may obtain the sound via the input device 150, or output the sound via the sound output device 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™ wireless-fidelity (Wi-Fi) direct, or infrared data association (IrDA)) or the second network 199 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., printed circuit board (PCB)). According to an embodiment, the antenna module 197 may include a plurality of antennas. In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 and 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, or client-server computing technology may be used, for example.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

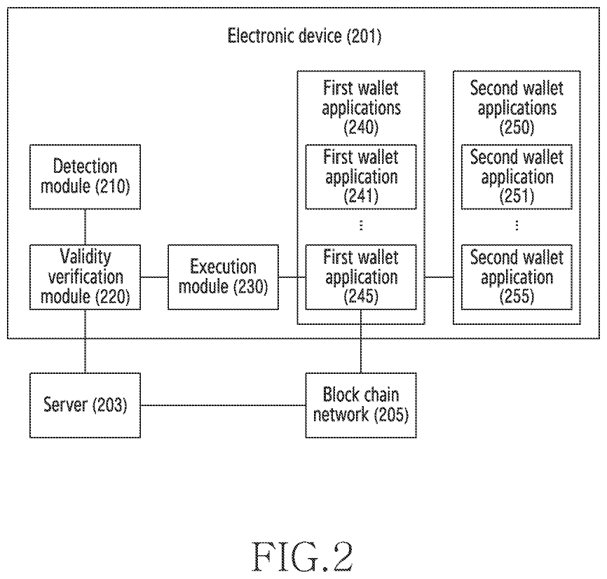

FIG. 2 is a diagram illustrating a configuration of an electronic device according to an embodiment of the disclosure.

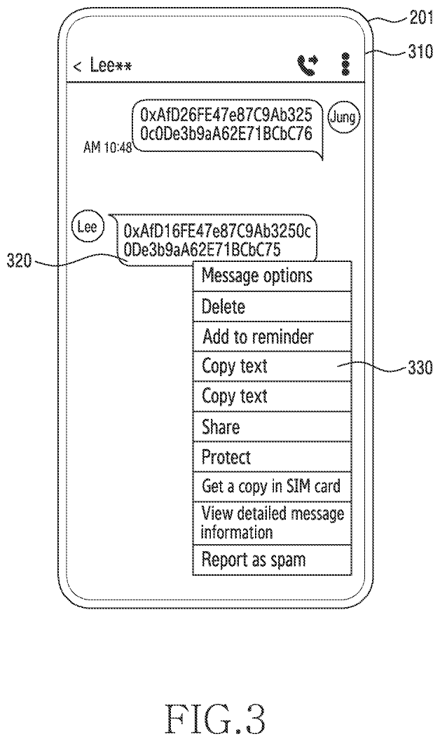

FIG. 3 is a diagram illustrating an example of recording data provided in a predetermined format by an electronic device according to an embodiment of the disclosure.

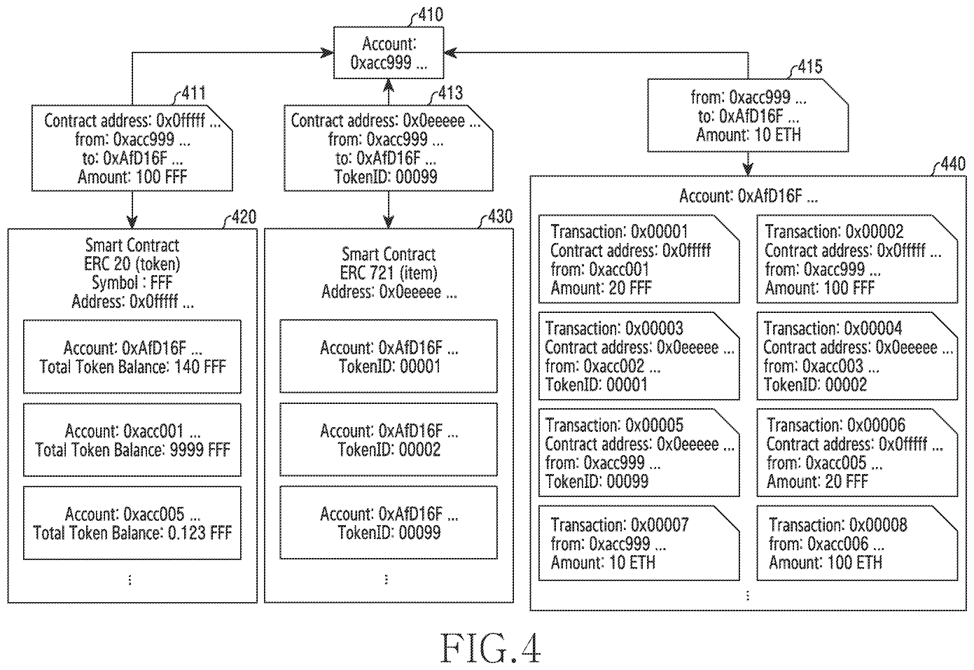

FIG. 4 is a diagram illustrating an example of a transaction between a user account and a counterpart account.

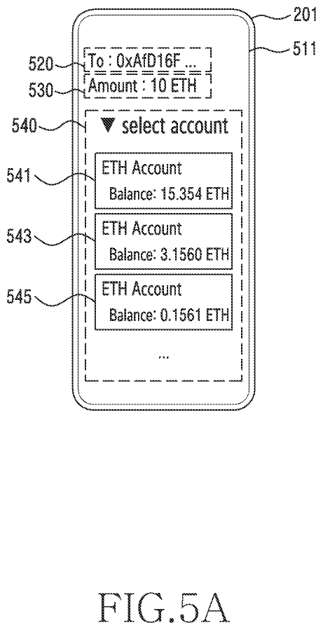

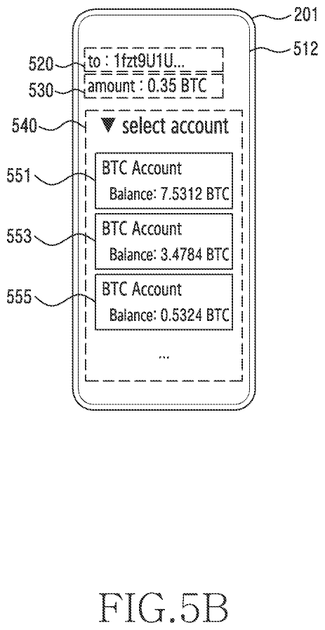

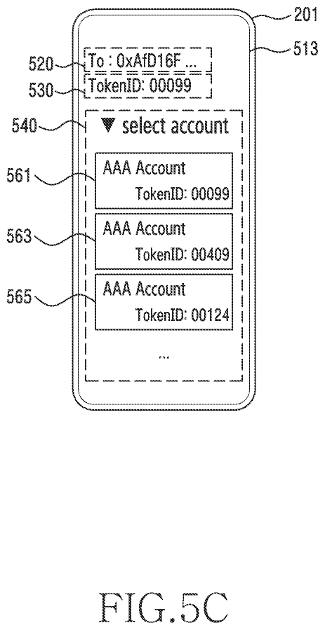

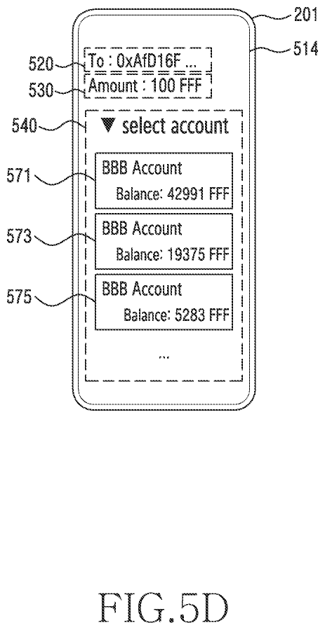

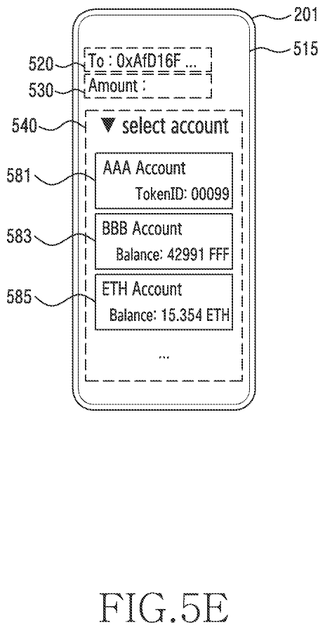

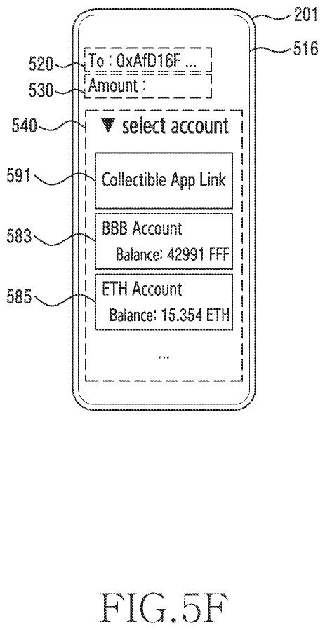

FIGS. 5A to 5F are diagrams illustrating examples of a screen of an electronic device which recommends user accounts according to an embodiment. The electronic device 201 of FIGS. 2, 3, 5A to 5F may correspond to the electronic device 101 of FIG. 1 according to various embodiments of the disclosure.

Referring to FIG. 2, an electronic device 201 may include a detection module 210, a validity verification module 220, an execution module 230, first wallet applications 240, second wallet applications 250, or a combination thereof.

According to an embodiment, the detection module 210, the validity verification module 220, the execution module 230, the first wallet applications 240, the second wallet applications 250, or a combination thereof may correspond to the program 140 of FIG. 1. According to an embodiment, the detection module 210, the validity verification module 220, the execution module 230, the first wallet applications 240, the second wallet applications 250, or a combination thereof may be operated by the program 140 of FIG. 1.

According to an embodiment, the detection module 210 may monitor a predetermined area (e.g., an area corresponding to a clipboard) of a memory (e.g., the memory 130 of FIG. 1). According to an embodiment, the detection module 210 may monitor whether data provided in a predetermined format is recorded in the predetermined area of the memory 130. According to an embodiment, the data provided in the predetermined format may at least include text including numbers, alphabet, or a combination thereof. According to an embodiment, the data provided in the predetermined format may include an image (e.g., quick response (QR) code or an image including text) indicating text including numbers, alphabet, or a combination thereof. According to an embodiment, the data provided in the predetermined format may include a voice signal from which text including numbers, alphabet, or a combination thereof may be extracted. According to an embodiment, the data provided in the predetermined format may at least include an account used in a decentralized network (e.g., a block chain network). According to an embodiment, the account used in the decentralized network (e.g., a block chain network) may be also referred to as an address (or a block chain address). According to an embodiment, the account may be an address used for a transaction of coins, tokens, or a combination thereof in the decentralized network (e.g., a block chain network). According to an embodiment, the coins may be cryptocurrency used in the decentralized network (e.g., a block chain network). According to an embodiment, the tokens may be assets that are capable of being transacted via a smart contract of the decentralized network (e.g., a block chain network). According to an embodiment, the tokens may be classified as a fungible token or a non-fungible token (NFT). According to an embodiment, the non-fungible token (NFT) may be a token that has a unique value. According to an embodiment, each non-fungible token may also be referred to as an item in a predetermined service.

According to an embodiment, the data provided in the predetermined format may represent a symbol (e.g., a symbol in a block chain service (e.g., a symbol of Ethereum (ETH)), a symbol of Bit Coin (BTC), or a symbol of a token (e.g., a symbol of Mosscoin (MOC), a symbol of Pundi X (NPXS), a symbol of OmiseGo (OMG), a symbol of VeChain (VEN))), a transaction amount, a transaction item, identification information associated with a smart contract (e.g., the address of a smart contract or the name of a smart contract), or information associated with a combination thereof.

Referring to FIG. 3, a user of the electronic device 201 may provide an input for copying text (copy text 330) in a message 320 received from an external electronic device (e.g., the electronic device 102 of FIG. 1) on a screen 310 of a messaging application. According to an embodiment, in response to the input for copying text (copy text) 330, the electronic device 201 may record data (i.e., text data) corresponding to the message 320 in a predetermined area of the memory 130.

According to an embodiment, if the data is recorded in the predetermined area of the memory 130, the detection module 210 may identify whether the data is data provided in a predetermined format. For example, if the data recorded in the predetermined area of the memory 130 is “0xAfD16FE47e87C9Ab3250c0De3b9aA62E71BCbC75” (hereinafter, “0xAfD16F . . . ”), the detection module 210 may identify that data including an account (or address) is recorded. In addition, for example, if the data recorded in the predetermined area of the memory 130 is “please send 10 ETH to 0xAfD16FE47e87C9Ab3250c0De3b9aA62E71BCbC75”, the detection module 210 may identify that data including an account (or address) is recorded. Here, “ETH” is a symbol of Ethereum, and “10” is a transaction amount. According to an embodiment, the account may also be referred to as a block chain account, an address, or a block chain address. According to an embodiment, “0xAfD16F . . . ” may be a first account.

According to an embodiment, if the data provided in the predetermined format is recorded in the predetermined area of the memory 130, the detection module 210 may report that the data provided in the predetermined format is recorded, to the validity verification module 220. According to an embodiment, by transmitting the data provided in the predetermined format to the validity verification module 220, the detection module 210 may report that the data provided in the predetermined format is recorded. According to an embodiment, by transmitting information associated with a location where the data in the predetermined format is recorded to the validity verification module 220, the detection module 210 may report that the data provided in the predetermined format is recorded.

According to an embodiment, the validity verification module 220 may identify the validity of the data recorded in the predetermined area of the memory 130. According to an embodiment, the validity verification module 220 may identify the validity of an account included in the data recorded in the memory 130.

According to an embodiment, the validity verification module 220 may identify an account from the data recorded in the predetermined area of the memory 130. According to an embodiment, the validity verification module 220 may identify a block chain service corresponding to the identified account. According to an embodiment, the validity verification module 220 may identify 40-digit hexadecimal data that begins with “0x” (i.e., 20-byte data including numbers and alphabet (e.g., alphabet from “a” to “f”)) as an account of Ethereum. According to an embodiment, the validity verification module 220 may identify 26-byte to 35-byte data, which includes hexadecimal data (numbers and alphabet (e.g., alphabet from “a” to “f”)) and begins with “1” or “3” as an account of Bit Coin. According to an embodiment, the validity verification module 220 may identify data, which includes “bitcoincash” as a prefix, uses “,” as a delimiter, begins with “q” or “p”, and includes hexadecimal data (numbers and alphabet (e.g., alphabet from “a” to “f”)), as an account of Bitcoin Cash.

According to an embodiment, the validity verification module 220 may identify the validity of the identified account based on an account generation algorithm (e.g., keccak256) corresponding to an identified block chain network. According to an embodiment, the validity verification module 220 may identify the identified account (e.g., 0xAfD16FE47e87C9Ab3250c0De3b9aA62E71BCbC75) as an account of Ethereum. According to an embodiment, the validity verification module 220 may apply “keccak256” which is the account generation algorithm of Ethereum to “AfD16FE47e87C9Ab3250c0De3b9aA62E71BCbC75” excluding “0x”, and based on the result of the application, may identify the validity of the identified account. According to an embodiment, if the result of applying “keccak256” shows that a value at the location of a capital letter of “AfD16FE47e87C9Ab3250c0De3b9aA62E71BCbC75” (e.g., 1st (i.e., the location of a first A), 3rd (i.e., the location of a first D), 6th (i.e., the location of a first F), 7th (i.e., the location of a first E), 13th (i.e., the location of a first C), 15th (i.e., the location of a second A), 23rd (i.e., the location of a second D), 29th (i.e., the location of a third A), 32nd (i.e., the location of a second E), 35th (i.e., the location of a first B), 36th (i.e., the location of a second C), 38th (i.e., the location of a third C)), excluding “0x” in the data is greater than a predetermined value (e.g., 0x8), the validity verification module 220 may identify that the identified account is valid. According to an embodiment, the method of identifying the validity of the identified account according to the account generation algorithm may be referred to as static validity verification.

According to an embodiment, the validity verification module 220 may request the identified block chain network (e.g., the block chain network 205) to inquire about the identified account. According to an embodiment, the validity verification module 220 may request a transaction history of the identified account from the identified block chain network 205. According to an embodiment, the validity verification module 220 may request the identified block chain network 205 to identify a transaction history of the identified account.

According to an embodiment, the validity verification module 220 may identify the validity of the identified account based on an inquiry result from the block chain network 205. According to an embodiment, the inquiry result from the block chain network 205 may be information associated with a transaction of the account, the balance in the account, or a combination thereof. According to an embodiment, the method of identifying the validity of the identified account using the block chain network may be referred to as dynamic validity verification.

According to an embodiment, the validity verification module 220 may request the server 203 to identify assets associated with the identified account. According to an embodiment, the validity verification module 220 may identify the validity of the identified account based on an asset identification result from the server 203. According to an embodiment, the server 203 may be a server which stores block chain data of the block chain network 205. According to an embodiment, the server 203 may be a server which stores asset information of accounts based on block chain data of the block chain network 205.

According to an embodiment, in response to the request for identifying the assets associated with the account, the server 203 may transmit an asset identification result associated with the account, identifying the assets of which is requested, to the validity verification module 220, and may recommend a user account that is capable of performing a transaction with the account, identifying the assets of which is requested, among user accounts of the electronic device 201.

Referring to FIG. 4, an account 440, identifying the assets of which is requested, may have at least one transaction history with another account (e.g., an account 410).

Referring to FIG. 4, the transaction history of the account 440, identifying the assets of which is requested, may include a transaction 411 based on a smart contract 420 associated with a token. According to an embodiment, the transaction 411 may include “0x0fffff” (here, “ . . . ” is an ellipsis, and “0x0fffff” may be 20-byte data), which is information associated with the address (contact address) of the smart contract 420. According to an embodiment, the transaction 411 may include “0xacc999 . . . ” (here, “ . . . ” is an ellipsis, and “0xacc999 . . . ” may be 20-byte data), which is information associated with the account 410 of a transmission side. According to an embodiment, the transaction 411 may include “0xAfD16F . . . ”, which is information associated with the account 440 of a reception side. According to an embodiment, the transaction 411 may include 100 FFF, which is information associated with the amount of tokens. According to an embodiment, “FFF” is a symbol of a token based on the smart contract 420. According to an embodiment, the smart contract 420 may be a smart contract associated with a token (e.g., a token based on Ethereum Request for Comment 20 (ERC 20)). According to an embodiment, a token may be Mosscoin (MOC), Pundi X (NPXS), OmiseGo (OMG), VeChain (VEN), or a combination thereof. Mosscoin (MOC), Pundi X (NPXS), OmiseGo (OMG), or VeChain (VEN) is merely an example of a token.

According to an embodiment, the server 203 may identify at least one transaction history of the account 440, identifying the assets of which is requested and which is related to the smart contract 420, and may identify the balance of tokens in the account 440, identifying the assets of which is requested, as 140 FFF.

Referring to FIG. 4, the transaction history of the account 440, identifying the assets of which is requested, may include a transaction 413 based on a smart contract 430 associated with an item. According to an embodiment, the transaction 413 may include “0x0eeeee . . . ” (here, “ . . . ” is an ellipsis, and “0x0eeeee . . . ” may be 20-byte data), which is information associated with the address of the smart contract 430. According to an embodiment, the transaction 413 may include “0xacc999 . . . ”, which is information associated with the account 410 of the transmission side. According to an embodiment, the transaction 413 may include “0xAfD16F . . . ”, which is information associated with the account 440 of the reception side. According to an embodiment, the transaction 413 may include 00099, which is information associated with a token identification (TokenID). According to an embodiment, the smart contract 430 may be a smart contract associated with a non-fungible token (NFT) (e.g., a token based on Ethereum Request for Comment 721 (ERC 721)). According to an embodiment, the non-fungible token (NFT) may be a token that has a unique value. For example, a token having “00099” as an identification (TokenID) and a token having “00098” as an identification (TokenID) may have different values from each other. According to an embodiment, a non-fungible token (NFT) may be CryptoKitties, Decentraland, or a combination thereof. CryptoKitties or Decentraland is merely an example of a non-fungible token (NFT).

According to an embodiment, the server 203 may identify at least one transaction history of the account 440, identifying the assets of which is requested and which is related to the smart contract 430, and may identify that the account 440, identifying the assets of which is requested, holds tokens having “00001”, “00002”, and “00099”, as identifications (TokenID).

Referring to FIG. 4, the transaction history of the account 440, identifying the assets of which is requested, may include a transaction 415 associated with a coin. According to an embodiment, the transaction 415 may not include information associated with the address of a smart contract. According to an embodiment, the transaction 415 may include “0xacc999 . . . ”, which is information associated with the account 410 of the transmission side. According to an embodiment, the transaction 415 may include “0xAfD16F . . . ”, which is information associated with the account 440 of the reception side. According to an embodiment, the transaction 415 may include 10 ETH, which is information associated with the amount of coins.

According to an embodiment, the server 203 may identify at least one transaction history of the account 440, identifying the assets of which is requested and which is related to a coin, and may identify the balance of coins in the account 440, identifying the assets of which is requested.

According to an embodiment, the server 203 may recommend, to the electronic device 201, a user account that holds a token based on the smart contract 420, an item based on the smart contract 430, a coin, or a combination thereof among user accounts of the electronic device 201.

According to an embodiment, the validity verification module 220 may identify the validity of data (i.e., an account) recorded in the memory 130, via the static validity verification, the dynamic validity verification, the validity verification using the server 203, or a combination thereof. According to an embodiment, if the validity of data (i.e., an account) is not identified via the dynamic validity verification, the validity verification module 220 may identify the validity of data (i.e., an account) recorded in the memory 130 via the validity verification using the server 203. According to an embodiment, the validity verification module 220 may identify the validity of data (i.e., an account) recorded in the memory 130, by simultaneously using the static validity verification and the dynamic validity verification.

According to an embodiment, if the validity of the data recorded in the memory 130 is identified, the validity verification module 220 may broadcast data including a predetermined parameter. According to an embodiment, if the validity of an account included in the data recorded in the memory 130 is identified, the validity verification module 220 may broadcast data including a predetermined parameter. According to an embodiment, the data including the predetermined parameter may be messaging data (e.g., intent). According to an embodiment, the predetermined parameter may be an execution condition for at least one of applications. According to an embodiment, the predetermined parameter may include information executable from the data recorded in the memory 130 (e.g., information associated with a block chain network, an account, a symbol (e.g., ETH), a transaction amount (e.g., a remittance), a transaction item, or a combination thereof).

For example, if it is identified that the data recorded in the predetermined area of the memory 130 is “0xAfD16FE47e87C9Ab3250c0De3b9aA62E71BCbC75”, and the account (“0xAfD16F . . . ”) included in the data recorded in the memory 130 is a valid account of Ethereum, the validity verification module 220 may broadcast an intent including a parameter indicating a block chain network (e.g., Ethereum), an account, a symbol (e.g., ETH), or a combination thereof. In addition, for example, if it is identified that the data recorded in the predetermined area of the memory 130 is “please send 10 ETH to 0xAfD16FE47e87C9Ab3250c0De3b9aA62E71BCbC75”, and the account included in the data recorded in the memory 130 is a valid account of Ethereum (“0xAfD16F . . . ”), the validity verification module 220 may broadcast an intent including a parameter indicating a block chain network (e.g., Ethereum), an account, a symbol (e.g., ETH), a transaction amount (e.g., 10 ETH), or a combination thereof.

According to an embodiment, based on the data broadcasted from the validity verification module 220, the execution module 230 may select at least one first wallet application (e.g., the first wallet application 241) among the first wallet applications 240. According to an embodiment, the execution module 230 may execute the selected first wallet application 241. According to an embodiment, each of the first wallet applications 240 may be an application that is capable of generating a transaction, and transmitting the generated transaction to the block chain network 205.

For example, the execution module 230 may execute a first wallet application (e.g., the first wallet application 241) that is capable of transmitting a transaction to a block chain network (e.g., Ethereum) indicated by broadcasted messaging data, among the first wallet applications 240.

According to an embodiment, the execution module 230 may provide, to the first wallet application 241, data broadcasted from the validity verification module 220. According to an embodiment, information provided to the first wallet application 241 may include information executable from the data recorded in the memory 130 (e.g., information associated with a block chain network (e.g., Ethereum), an account, a symbol (e.g., ETH), a transaction amount (e.g., a remittance), a transaction item, or a combination thereof).

According to an embodiment, the first wallet application 241 may display, on a display device (e.g., the display device 160 of FIG. 1), a screen showing payment information based on data broadcasted from the validity verification module 220, data provided from the execution module 230, data provided from the server 203, or a combination thereof. According to an embodiment, the screen representing the payment information may be referred to as a user interface (UI).

According to an embodiment, if two or more user accounts are present, the first wallet application 241 may line up the two or more user accounts in a predetermined order. In addition, the first wallet application 241 may display a screen showing payment information including the two or more lined up user accounts, on the display device 160. According to an embodiment, the predetermined order may be an order or use of the two or more user accounts of the user of the electronic device 201 (e.g., an order of the two or more user accounts which is determined based on the frequency of selection by the user), an order of use associated with a user account identified based on a transaction history related to the first account (e.g., an order of the two or more user accounts which is determined based on the frequency of transaction with the first account), an order of at least one second block chain address which is identified based on the transaction object of the first account (e.g., an order of the two or more user accounts which is determined based on the frequency of transaction of assets corresponding to assets, of which transaction history related to the first account is the largest), or an order determined based on a combination thereof. According to an embodiment, a user account may be identified based on data provided from the server 203.

According to an embodiment, the data provided from the server 203 may include information associated with a user account corresponding to an identified account from among at least one user account. According to an embodiment, the data provided from the server 203 may include information associated with a user account that holds assets corresponding to assets of an identified account from among at least one user account. According to an embodiment, the data provided from the server 203 may be data received from the server 203 in response to a request for identifying assets of an identified account, transmitted from the validity verification module 220 to the server 203. According to an embodiment, the data provided from the server 203 may be data received from the server 203 in response to a request for recommending a user account, transmitted from the first wallet application 241 to the server 203.

Referring to FIG. 5A, a screen 511 of the first wallet application 241 of the electronic device 201 may include payment information based on data broadcasted from the validity verification module 220, data provided from the execution module 230, data provided from the server 203, or a combination thereof.

Referring to FIGS. 5A to 5F, each of the screens 511 to 516 may include a reception account area 520, a transaction item area 530, a transmission account recommendation area 540, or a combination thereof.

Referring to FIGS. 5A to 5F, each of the screens 511 to 516 may display the account of a reception side (e.g., “0xAfD16F . . . ” or “1fzt9U1U . . . ”) in the reception account area 520. According to an embodiment, the reception side account (e.g., “0xAfD16F . . . ” or “1fzt9U1U . . . ”) may be information extracted from data broadcasted from the validity verification module 220 or data provided from the execution module 230. According to an embodiment, the account of the reception side (e.g., “0xAfD16F . . . ” or “1fzt9U1U . . . ”) may be information included in data which is provided in a predetermined format and is recorded in a predetermined area of the memory 130. However, this is merely an example, and the account of the reception side (e.g., “0xAfD16F . . . ” or “1fzt9U1U . . . ”) may be obtained from a user via an input device (e.g., the input device 150 of FIG. 1) or a touch screen of a display device (e.g., the display device 160 of FIG. 1). For example, the first wallet application 241 may obtain an account (e.g., “0xAfD16F . . . ” or “1fzt9U1U . . . ”) that a user inputs to the reception account area 520 of the screen 511 using an input device (e.g., the input device 150 or a virtual keyboard on the touch screen of the display device 160).

Referring to FIGS. 5A to 5F, each of the screens 511 to 516 may display transaction information (e.g., a symbol, a transaction amount, a transaction item, or a combination thereof) in the transaction item area 530 of each screen 511 to 516. According to an embodiment, the transaction information may be information extracted from data broadcasted from the validity verification module 220, data provided from the execution module 230, or data provided from the server 203. According to an embodiment, the transaction information may be information included in data which is provided in a predetermined format and is recorded in a predetermined area of the memory 130. However, this is merely an example, and at least a part of the transaction information may be obtained from a user via the input device 150 or the touch screen of the display device 160. For example, the first wallet application 241 may obtain transaction information (e.g., a symbol, a transaction amount, a transaction item, or a combination thereof) that a user inputs to the transaction item area 530 of the screen 511 using an input device (e.g., the input device 150 or a virtual keyboard on the touch screen of the display device 160).

Referring to FIGS. 5A to 5F, at least one user account may be display in the transmission account recommendation area 540 of each screen 511 to 516. According to an embodiment, the at least one user account may be an account that is capable of performing a transaction with the account (“0xAfD16F . . . ” or “1fzt9U1U . . . ”) of the reception side.

According to an embodiment, if “0xAfD16F . . . ”, which is the account of the reception side, is a valid account of Ethereum, at least one user account 541, 543, and 545 that holds a coin of Ethereum may be displayed in the transmission account recommendation area 540, as illustrated in FIG. 5A. According to an embodiment, the at least one user account 541, 543, and 545 may be information extracted from data provided from the server 203. As illustrated in FIG. 5A, information associated with the amount of coins that each user account 541, 543, and 545 holds may be displayed in the transmission account recommendation area 540.

According to an embodiment, if “0xAfD16F . . . ”, which is the account of the reception side, is a valid account of Ethereum, and information associated with a block chain network (e.g., Ethereum), a symbol (e.g., ETH), or a combination thereof is included in the data recorded in the memory 130, at least one user account 541, 543, and 545 that holds a coin of Ethereum may be displayed in the transmission account recommendation area 540, as illustrated in FIG. 5A. According to an embodiment, the at least one user account 541, 543, and 545 may be information extracted from data provided from the server 203.

According to an embodiment, if “1fzt9U1U . . . ”, which is the account of the reception side, is a valid account of Bit Coin, at least one user account 551, 553, and 555 that holds a coin of Bit Coin may be displayed in the transmission account recommendation area 540, as illustrated in FIG. 5B. According to an embodiment, the at least one user account 551, 553, and 555 may be information extracted from data provided from the server 203. Referring to FIG. 5B, information associated with the amount of coins that each user account 551, 553, and 555 holds may be displayed in the transmission account recommendation area 540.

According to an embodiment, if “1fzt9U1U . . . ”, which is the account of the reception side, is a valid account of Bit Coin, and information associated with a block chain network (e.g., Bit coin), a symbol (e.g., BTC), or a combination thereof is included in data recorded in the memory 130, at least one user account 551, 553, and 555 that holds a coin of Bit Coin may be displayed in the transmission account recommendation area 540, as illustrated in FIG. 5B. According to an embodiment, the at least one user account 551, 553, and 555 may be information extracted from data provided from the server 203.

According to an embodiment, if “0xAfD16F . . . ”, which is the account of the reception side, is a valid account of Ethereum, at least one user account 561, 563, and 565 that holds a non-fungible token (e.g., an item) of a smart contract of Ethereum may be displayed in the transmission account recommendation area 540, as illustrated in FIG. 5C. According to an embodiment, if “0xAfD16F . . . ”, which is the account of the reception side, is a valid account of Ethereum, and a transaction related to a smart contract associated with a non-fungible token is made, at least one user account 561, 563, and 565 that holds a non-fungible token (e.g., an item) of a corresponding smart contract may be displayed in the transmission account recommendation area 540, as illustrated in FIG. 5C. According to an embodiment, the at least one user account 561, 563, and 565 may be information extracted from data provided from the server 203. As illustrated in FIG. 5C, information associated with a retained item related to a smart contract which each user account 561, 563, and 565 holds may be displayed in the transmission account recommendation area 540.

According to an embodiment, if “0xAfD16F . . . ”, which is the account of the reception side, is a valid account of Ethereum, and identification information associated with a smart contract (e.g., the address of a smart contract or the name of a smart contract) is included in data recorded in the memory 130, at least one user account 561, 563, and 565 which holds an item of the corresponding smart contract may be displayed in the transmission account recommendation area 540, as illustrated in FIG. 5C. According to an embodiment, the at least one user account 561, 563, and 565 may be information extracted from data provided from the server 203.

According to an embodiment, if “0xAfD16F . . . ”, which is the account of the reception side, is a valid account of Ethereum, at least one user account 571, 573, and 575 that holds a fungible token of a smart contract associated with a fungible token may be displayed in the transmission account recommendation area 540, as illustrated in FIG. 5D. According to an embodiment, if “0xAfD16F . . . ”, which is the account of the reception side, is a valid account of Ethereum, and a transaction related to a smart contract associated with a fungible token is made, at least one user account 571, 573, and 575 that holds a fungible token of the corresponding smart contract may be displayed in the transmission account recommendation area 540, as illustrated in FIG. 5D. According to an embodiment, the at least one user account 571, 573, and 575 may be information extracted from data provided from the server 203. As illustrated in FIG. 5D, information associated with a retained token related to a smart contract which each user account 571, 573, and 575 holds may be displayed in the transmission account recommendation area 540.

According to an embodiment, if “0xAfD16F . . . ”, which is the account of the reception side, is a valid account of Ethereum, and identification information associated with a smart contract (e.g., the address of a smart contract or the name of a smart contract) is included in the data recorded in the memory 130, at least one user account 571, 573, and 575 which holds a token of the smart contract may be displayed in the transmission account recommendation area 540, as illustrated in FIG. 5D. According to an embodiment, the at least one user account 571, 573, and 575 may be information extracted from data provided from the server 203.

According to an embodiment, if “0xAfD16F . . . ”, which is the account of the reception side, is a valid account of Ethereum, at least one user account 581, 583, and 585 which holds assets (e.g., coins, tokens, items, or a combination thereof) related to Ethereum may be displayed in the transmission account recommendation area 540, as illustrated in FIG. 5E. According to an embodiment, if “0xAfD16F . . . ”, which is the account of the reception side, is a valid account of Ethereum, and a transaction associated with assets (e.g., coins, tokens, items, or a combination thereof) related to Ethereum is made, at least one user account 581, 583, and 585 that holds assets (e.g., coins, tokens, items, or a combination thereof) related to Ethereum may be displayed in the transmission account recommendation area 540, as illustrated in FIG. 5E. According to an embodiment, the at least one user account 581, 583, and 585 may be information extracted from data provided from the server 203. As illustrated in FIG. 5E, information associated with a retained token related to a smart contract which each user account 581, 583, and 585 holds may be displayed in the transmission account recommendation area 540.

Referring to FIG. 5E, a user account 581 may be a user account that is capable of performing an item transaction with “0xAfD16F . . . ” which is the account of the reception side. Referring to FIG. 5E, a user account 583 may be a user account that is capable of performing a token transaction with “0xAfD16F . . . ” which is the account of the reception side. Referring to FIG. 5E, a user account 585 may be a user account that is capable of performing a coin transaction with “0xAfD16F . . . ” which is the account of the reception side. According to an embodiment, the order of the user accounts 581, 583, and 585 may be determined based on the propensity of transaction of the account of the reception side, “0xAfD16F . . . ”. According to an embodiment, the order of the user accounts 581, 583, and 585 may be determined based on information extracted from the data provided form the server 203.

According to an embodiment, if “0xAfD16F . . . ”, which is the account of the reception side, is an account for performing an item transaction, an object 591 indicating interoperation with another first wallet application 245 that is connected to the corresponding item may be displayed in the transmission account recommendation area 540, as illustrated in FIG. 5F. According to an embodiment, if a user input for selecting the object 591 is identified, the electronic device 201 may execute the first wallet application 245. According to an embodiment, if the user input for selecting the object 591 is identified, the first wallet application 241 may provide information associated with “0xAfD16F . . . ”, which is the account of the reception side, transaction information (e.g., a symbol, a transaction amount, a transaction item, or a combination thereof), or a combination thereof, to the first wallet application 245.

According to an embodiment, in each screen 511 to 516, the first wallet application 241 may request at least one second wallet application 251 of the second wallet applications 250 to sign a transaction in response to a user input for requesting transmission of a transaction to the block chain network 205. According to an embodiment, the first wallet application 241 may identify a user input for selecting one of the user accounts displayed in the transmission account recommendation area 540 of each screen 511 to 516, as a user input for requesting transmission of a transaction to the block chain network 205. According to an embodiment, the transaction may include information associated with the account of the reception side, transaction information (e.g., a symbol, a transaction amount, a transaction item, or a combination thereof), and an account of a transmission side.

According to an embodiment, the first wallet application 241 may request at least one second wallet application 251 of the second wallet applications 250 to sign a transaction in response to a user input for selecting one of the user accounts displayed in the transmission account recommendation area 540 of each screen 511 to 516. According to an embodiment, the first wallet application 241 may request the second wallet application 251, which is capable of signing a transaction related to the block chain network 205 among the second wallet applications 250, to sign a transaction. According to an embodiment, the first wallet application 241 may request the second wallet application 251, which is capable of signing a transaction related to an account of a transmission side among the second wallet applications 250, to sign a transaction.

According to an embodiment, the second wallet application 251 may sign a transaction received from the first wallet application 241 using a private key related to the account of the transmission side. According to an embodiment, the second wallet application 251 may transmit the signed transaction to the first wallet application 241.

According to an embodiment, the first wallet application 241 may transmit the signed transaction to the block chain network 205, and may complete the transaction between the account of the reception side and the account of the transmission side.

According to an embodiment, the server 203 may pool at least a part of block chain data from the block chain network 205. According to an embodiment, the server 203 may store at least the part of the block chain data pooled from the block chain network 205 separately from the block chain network 205.

According to an embodiment, the server 203 may observe an event log occurring at the point in time at which a block is produced in the block chain network 205. According to an embodiment, if a predetermined event log is identified, the server 203 may store an event in which the identified event log appears in a separate database. For example, the server 203 may identify a predetermined event log (e.g., a log indicating the occurrence of transferFrom( )) in a smart contract related to a decentralized application (DApp) of the block chain network 205. According to an embodiment, the server 203 may store information associated with the identified event log (e.g., a log indicating the occurrence of transferFrom( )) (e.g., a uniform resource identifier (URI), a reception side account, a transmission side account, an item (TokenID), and attributes of an item (TokenID)) in a separate database. According to an embodiment, the predetermined event log may be a log for detecting an event that corresponds to a predetermined standard (e.g., ERC-721 and ERC-20). According to an embodiment, the predetermined event log may be a log for detecting an event related to a predetermined smart contract. According to an embodiment, the predetermined event log may be a log for detecting an event related to execution of a predetermined function (e.g., .transferFrom( )).

According to an embodiment, the server 203 may store information related to an item among the information associated with the identified event log in a separate database, as materials provided in the format of Table 1 below.

```
TABLE 1
{
    ″title″: ″Asset Metadata″,
    ″type″: ″object″,
    ″properties″: {
      ″name″: {
        ″type″: ″string″,
        ″description″: ″Identifies the asset to which this NFT represents″,
      },
      ″description″: {
        ″type″: ″string″,
        ″description″: ″Describes the asset to which this NFT represents″,
      },
      ″image″: {
        ″type″: ″string″,
        ″description″: ″A URI pointing to a resource with mime type
image/* representing the asset to which this NFT represents. Consider
making any images at a width between 320 and 1080 pixels and aspect
ratio between 1.91:1 and 4:5 inclusive.″,
      },
  ″attributes″ (added): {
        ″type″: ″object″,
        ″description″: ″Arbitrary properties. Values may be strings,
  numbers, object or arrays.″,
      },
    }
}
```

Referring to Table 1, materials representing an item may include information associated with a title, a type, properties, or attributes. Referring to Table 1, “properties” in the materials representing the item may include information associated with a name, descriptions, or images. Referring to Table 1, “attributes” in the materials representing the item may include information associated with a type and descriptions.

According to an embodiment, Table 2 shows information associated with “properties” or “attributes” in the materials representing the item.

```
TABLE 2
{
  ″name″: ″MCH Extension: #20210385 Lv.60″,
  ″description″:″ExtensionName: Elite Tiger\nNickname: [symbol]    ″,
  ″image″:″https://www.mycryptoheroes.net/images/extensions/2000/
  2021.png″,
  ″attributes″: {
    ″id″:20210385,
    ″ExtensionName″:″″,
    ″lv″:60,
    ″rarity″:″Uncommon″,
    ″hp″:0,
    ″phy″:66,
    ″int″:0,
    ″agi″:23,
    ″active_skill″:″Elite Tiger Fang″
  }
}
```

Referring to Table 2, the name is “MCH Extension: #20210385 Lv. 60”, the description is “ExtensionName: Elite Tiger\nNickname: [symbol] ”, and the URI of the image is “https://www.mycryptoheroes.net/images/extensions/2000/2021.png”.

Referring to Table 2, “attributes” may include information associated with an ID, an extension name (ExtensionName), a level (lv), rarity, hp, phy, int, agi, and an activated skill.

Referring to Table 2, the ID is “20210385”. Referring to Table 2, the extension name is “null”. Referring to Table 2, the level (lv) is 60. Referring to Table 2, the rarity is “uncommon”. Referring to Table 2, hp is 0. Referring to Table 2, phy is 66. Referring to Table 2, int is 0. Referring to Table 2, agi is 23. Referring to Table 2, the activated skill is “Elite Tiger Fang”.

According to an embodiment, the server 203 may store information related to an account among the information associated with the identified event log in a separate database, as materials provided in the format of Table 3 below.

TABLE 3

| | | | Number of |
|---|---|---|---|
| | | | times of |
| Account | Type | Balance | transactions |
| 0xAfD16F | Ethereum | 3.7 ETH | 57 |
| . . . | Maker-0x9f8f72 . . . | 2.7 MKR | 5 |
| | Moss Coin-0x865ec5 . . . | 0 MOC | 4 |
| | CryptoKitties-0x96912c . . . | 2 EA | 25 |

Referring to Table 3, it is identified that the account, “0xAfD16F . . . ”, holds coins corresponding to 3.7 ETH via transactions performed 57 times. Referring to Table 3, it is identified that the account, “0xAfD16F . . . ”, holds tokens corresponding to 2.7 MKR via transactions performed 5 times in association with a smart contract having an address of “0x9f8f72 . . . ”. According to an embodiment, the smart contract having an address of “0x9f8f72 . . . ” may be a smart contract associated with Maker which has MKR as a symbol. Referring to Table 3, it is identified that the account, “0xAfD16F . . . ”, holds tokens corresponding to 0 MOC via transactions performed 4 times in association with a smart contract having an address of “0x865ec5 . . . ”. According to an embodiment, the smart contract having an address of “0x865ec5 . . . ” may be a smart contract associated with Moss Coin which has MOC as a symbol. Referring to Table 3, it is identified that the account, “0xAfD16F . . . ”, holds two items (i.e., non-fungible coins) via transactions performed 25 times in association with a smart contract having an address of “0x96912c . . . ”. According to an embodiment, the smart contract having an address of “0x96912c . . . ” may be a smart contract associated with CryptoKitties.

According to an embodiment, the server 203 may identify assets associated with the account, “0xAfD16F . . . ”, based on the materials provided in the format of Table 3, in response to a request from the electronic device 201 (e.g., a request for identifying assets associated with an account or a request for recommending a user account). According to an embodiment, the server 203 may identify assets associated with “0xAfD16F . . . ”, and may identify a user account that holds assets corresponding to the assets retained in “0xAfD16F . . . ”.

According to an embodiment, the server 203 may store information related to a user account of the electronic device 201 in a separate database, as materials provided in the format of Tables 4 to 7 provided below.

TABLE 4

| | | | Number of |
|---|---|---|---|
| | | | times of |
| Account | Type | Balance | transactions |
| User | Ethereum | 1.7 ETH | 17 |
| account A | | | |

Referring to Table 4, it is identified that user account A holds coins corresponding to 1.7 ETH via transactions performed 17 times. According to an embodiment, the user account A might not perform a transaction related to a smart contract having an address of “0x9f8f72 . . . ”, a smart contract having an address of “0x865ec5 . . . ”, or a smart contract having an address of “0x96912c . . . ”.

TABLE 5

| | | | Number of |
|---|---|---|---|
| | | | times of |
| Account | Type | Balance | transactions |
| User | Ethereum | 0 ETH | 6 |
| account B | Moss Coin-0x865ec5 . . . | 0 MOC | 6 |
| | CryptoKitties-0x96912c . . . | 5 EA | 7 |

Referring to Table 5, it is identified that user account B holds coins corresponding to 0 ETH via transactions performed 6 times. Referring to Table 5, it is identified that the user account B holds tokens corresponding to 0 MOC via transactions performed 6 times in association with a smart contract having an address of “0x865ec5 . . . ”. Referring to Table 5, it is identified that the user account B holds five items (i.e., non-fungible coins) via transactions performed 7 times in association with a smart contract having an address of “0x96912c . . . ”. According to an embodiment, the user account B might not perform a transaction related to a smart contract having an address of “0x9f8f72 . . . ”.

TABLE 6

| | | | Number of |
|---|---|---|---|
| | | | times of |
| Account | Type | Balance | transactions |
| User | Ethereum | 1.2 ETH | 16 |
| account C | Maker-0x9f8f72 . . . | 0 MKR | 8 |

Referring to Table 6, it is identified that user account C holds coins corresponding to 1.2 ETH via transactions performed 16 times. Referring to Table 6, it is identified that the user account C holds tokens corresponding to 0 MKR via transactions performed 8 times in association with a smart contract having an address of “0x9f8f72 . . . ”. According to an embodiment, the user account C might not perform a transaction related to a smart contract having an address of “0x865ec5 . . . ”. According to an embodiment, the user account C might not perform a transaction related to a smart contract having an address of “0x96912c . . . ”.

TABLE 7

| | | | Number of |
|---|---|---|---|
| | | | times of |
| Account | Type | Balance | transactions |
| User | Ethereum | 0.2 ETH | 36 |
| account D | CryptoKitties-0x96912c . . . | 2 EA | 22 |
| | DozerDoll-0xBd13e5 . . . | 1 EA | 1 |
| | OmiseGo-0xd26114 . . . | 0 OMG | 2 |

Referring to Table 7, it is identified that user account D holds coins corresponding to 0.2 ETH via transactions performed 36 times. Referring to Table 7, it is identified that the user account D holds two items via transactions performed 22 times in association with a smart contract having an address of “0x96912c . . . ”. Referring to Table 7, it is identified that the user account D holds one item via transactions performed 2 times in association with a smart contract having an address of “0xBd13e5 . . . ”. According to an embodiment, the smart contract having an address of “0xBd13e5 . . . ” may be a smart contract associated with DozerDoll. Referring to Table 7, it is identified that the user account D holds tokens corresponding to 0 OMG via transactions performed 2 times in association with a smart contract having an address of “0xd26114 . . . ”. According to an embodiment, the smart contract having an address of “0xd26114 . . . ” may be a smart contract associated with OmiseGo which has OMG as a symbol. According to an embodiment, the user account D might not perform a transaction related to a smart contract having an address of “0x9f8f72 . . . ”. According to an embodiment, the user account D might not perform a transaction related to a smart contract having an address of “0x865ec5 . . . ”.

According to an embodiment, in response to a request from the electronic device 201 (e.g., a request for identifying assets associated with an account or a request for recommending a user account), the server 203 may extract data from a database of the server 203, and may provide the extracted data to the electronic device 201.

According to an embodiment, in response to the request for identifying assets associated with an account from the electronic device 201, the server 203 may identify a user account with which a transaction of assets corresponding to the assets retained in the account (e.g., “0xAfD16F . . . ”), identifying the assets of which is requested, was performed among user accounts. According to an embodiment, the server 203 may provide, to the electronic device 201, information associated with a user account that holds assets corresponding to the assets retained in the account (e.g., “0xAfD16F . . . ”), identifying the assets of which is requested, among the identified user accounts.

According to an embodiment, if two or more user accounts are present, which hold assets corresponding to the assets retained in the account (e.g., “0xAfD16F . . . ”), identifying the assets of which is requested, the server 203 may provide, to the electronic device 201, information associated with a predetermined number of user accounts among the two or more user accounts. According to an embodiment, the predetermined number of user accounts may be user accounts that are selected in order of the amount of assets corresponding to the assets retained in the account (e.g., “0xAfD16F . . . ”), identifying the assets of which is requested. According to an embodiment, at least one user account may be user accounts that are selected in order of the number of transactions performed in association with assets corresponding to the assets retained in the account (e.g., “0xAfD16F . . . ”), identifying the assets of which is requested.

According to an embodiments, if two or more types of assets are retained in the account (“0xAfD16F . . . ”), identifying the assets of which is requested, and at least one user account is present, which retains assets respectively corresponding to the two or more types of retained assets, the server 203 may select a predetermined number of types of retained assets. According to an embodiment, the server 203 may provide, to the electronic device 201, information associated with a user account that holds assets corresponding to the selected predetermined number of types of retained assets. According to an embodiment, the predetermined number of types may be selected in order of the number of transactions performed in association with a corresponding type among the types of the retained assets of the account (e.g., “0xAfD16F . . . ”), identifying the assets of which is requested. According to an embodiment, the predetermined number of types may be selected in order of generation of a transaction associated with a corresponding type among the types of the retained assets of the account (e.g., “0xAfD16F . . . ”), identifying the assets of which is requested.

According to an embodiment, if two or more user accounts are present, which hold assets corresponding to the assets retained in the account (e.g., “0xAfD16F . . . ”), identifying the assets of which is requested, the server 203 may provide information associated with the two or more user accounts to the electronic device 201, and may provide information associated with priorities of the two or more user accounts to the electronic device 201. According to an embodiment, the priorities of the two or more user accounts may be user accounts that are selected in order of the amount of assets corresponding to the assets retained in the account (e.g., “0xAfD16F . . . ”), identifying the assets of which is requested. According to an embodiment, at least one user account may be user accounts that are selected in order of the number of transactions performed in association with assets corresponding to the assets retained in the account (e.g., “0xAfD16F . . . ”), identifying the assets of which is requested.

According to an embodiment, in the process of recommending a user account for performing a transaction of a first coin (e.g., a coin of Ethereum) among assets that the account (e.g., “0xAfD16F . . . ”) holds, the server 203 may identify a user account with which a transaction associated with a first coin was performed among user accounts in response to a request (a user account recommendation request) for identifying assets associated with the account (e.g., “0xAfD16F . . . ”) from the electronic device 201. According to an embodiment, in the process of recommending a user account for performing a transaction of a first coin, the server 203 may provide, to the electronic device 201, information associated with a user account that holds a first coin among the identified user accounts.

According to an embodiment, the server 203 may identify user accounts A to D with which transactions associated with a coin of Ethereum were performed as user accounts for performing a transaction of a coin of Ethereum. According to an embodiment, the server 203 may provide, to the electronic device 201, information associated with user account A, C, D, or a combination thereof, which holds a coin of Ethereum among user accounts A to D. According to an embodiment, the server 203 may not provide, to the electronic device 201, information associated with user account B that does not hold a coin of Ethereum among user accounts A to D.

According to an embodiment, the server 203 may provide, to the electronic device 201, information associated with a predetermined number of user accounts among user account A, C, and D which hold a coin of Ethereum, based on the amount of retained first coins, the number of times of transactions of a first coin, or a combination thereof.

According to an embodiment, the server 203 may provide, to the electronic device 201, information associated with a priority associated with user accounts A, C, and D which hold a coin of Ethereum.

According to an embodiment, in the process of recommending a user account for performing a transaction of a first token (e.g., token of Maker (MKR)) among assets that the account (e.g., “0xAfD16F . . . ”) holds, the server 203 may identify a user account with which a transaction associated with a first token was performed among user accounts in response to a request (a user account recommendation request) for identifying assets associated with the account (e.g., “0xAfD16F . . . ”) from the electronic device 201. According to an embodiment, in the process of recommending a user account for performing a transaction of a first token, the server 203 may provide, to the electronic device 201, information associated with a user account that holds a first coin and a first token among the identified user accounts. According to an embodiment, a smart contract associated with a first token may be a smart contract recorded in a block chain network (e.g., Ethereum) associated with a first coin.

According to an embodiment, the server 203 may identify user account C with which a transaction associated with a token of Maker (MKR) was performed, as a user account for performing a transaction of a token of Maker (MKR). According to an embodiment, the server 203 may not provide, to the electronic device 201, information associated with user account C since user account C does not hold a token of Maker (MKR). According to an embodiment, the server 203 may not provide, to the electronic device 201, information associated with user accounts A, B, and D with which transactions associated with a token of Maker (MKR) were not performed.

According to an embodiment, the server 203 may identify user account B with which a transaction associated with a token of Moss Coin (MOC) was performed, as a user account for performing a transaction of a token of Moss Coin (MOC). According to an embodiment, the server 203 may not provide, to the electronic device 201, information associated with user account B since user account B does not hold a token of Moss Coin (MOC). According to an embodiment, the server 203 may not provide, to the electronic device 201, information associated with user account B since user account B does not hold a coin of Ethereum. According to an embodiment, the server 203 may not provide, to the electronic device 201, information associated with user accounts A, C, and D with which transactions associated with a token of Moss Coin (MOC) were not performed.

According to an embodiment, the server 203 may identify user accounts B and D with which transactions associated with an item of CryptoKitties (i.e., a non-fungible token) were performed, as user accounts for performing a transaction of an item of CryptoKitties.

According to an embodiment, the server 203 may provide, to the electronic device 201, information associated with user account D that holds an item of CryptoKitties and a coin of Ethereum among user accounts B and D. According to an embodiment, the server 203 may not provide, to the electronic device 201, information associated with user account B since user account B does not hold a coin of Ethereum. According to an embodiment, the server 203 may not provide, to the electronic device 201, information associated with user accounts A and C with which transactions associated with an item of CryptoKitties were not performed.

According to an embodiment, the server 203 may provide, to the electronic device 201, information associated with user accounts A, C, D, or a combination thereof, as a user account for performing a transaction of a coin of Ethereum. According to an embodiment, the server 203 may provide, to the electronic device 201, information associated with user account D, as a user account for performing a transaction of an item of CryptoKitties.

According to an embodiment, there are two asset types (e.g., a coin of Ethereum and an item of CryptoKitties), which are capable of performing a transaction with “0xAfD16F . . . ” and thus, the server 203 may select “a coin of Ethereum” of which the number of transactions is larger than the other between the two asset types. According to an embodiment, if “a coin of Ethereum” is selected, the server 203 may provide, to the electronic device 201, information associated with user accounts A, C, and D as user accounts for performing a transaction of a coin of Ethereum, among user accounts A, C, and D as user accounts for performing a transaction of a coin of Ethereum and user account D as a user account for performing a transaction of an item of CryptoKitties.

According to an embodiment, the block chain network 205 may receive a signed transaction from the electronic device 201.

According to an embodiment, the block chain network 205 may record, in block chain data, the signed transaction received from the electronic device 201. According to an embodiment, the block chain network 205 may include the signed transaction in a newly produced block, and may record the signed transaction in the block chain data.

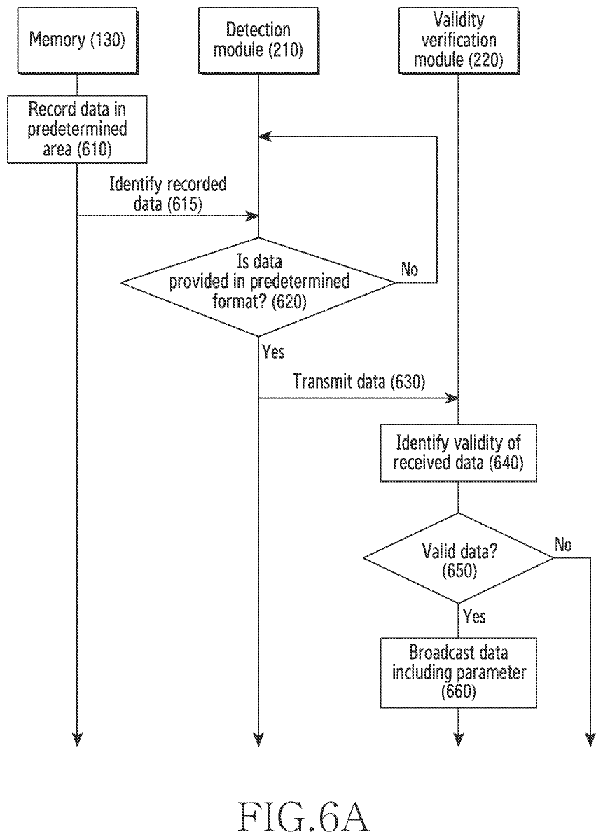

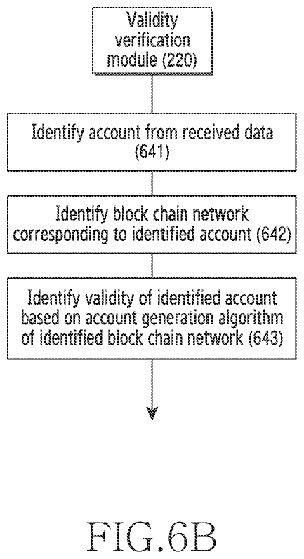

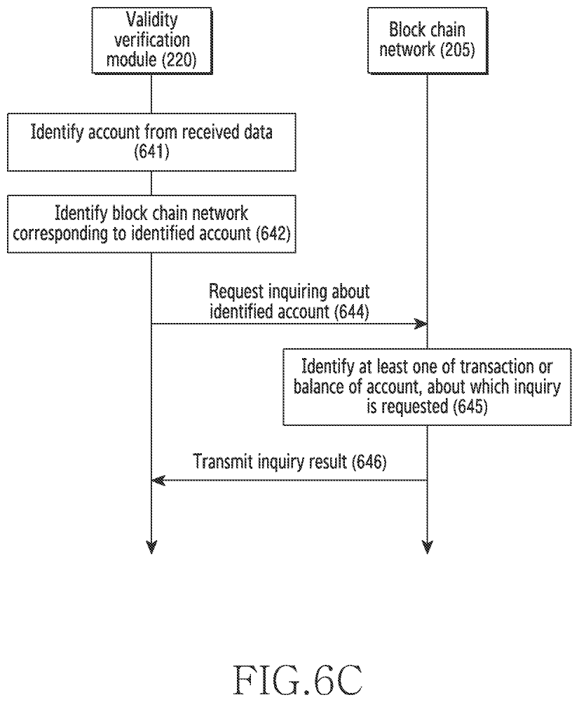

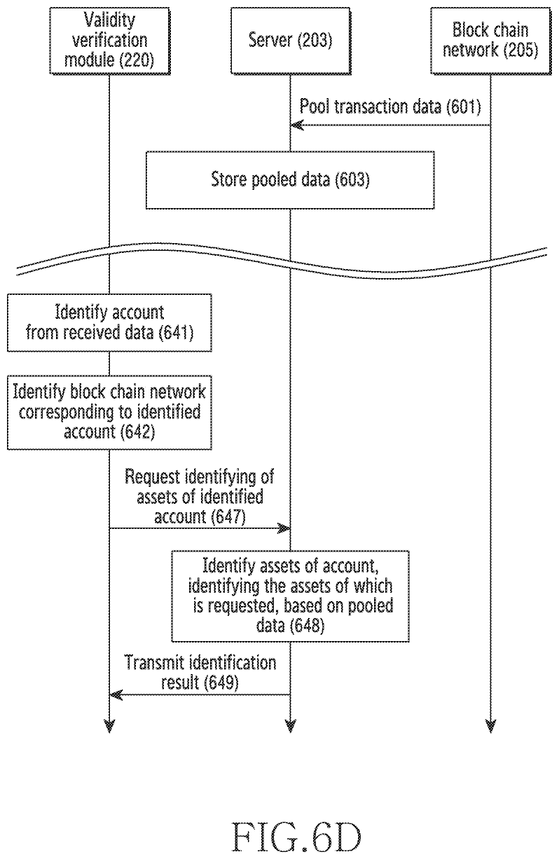

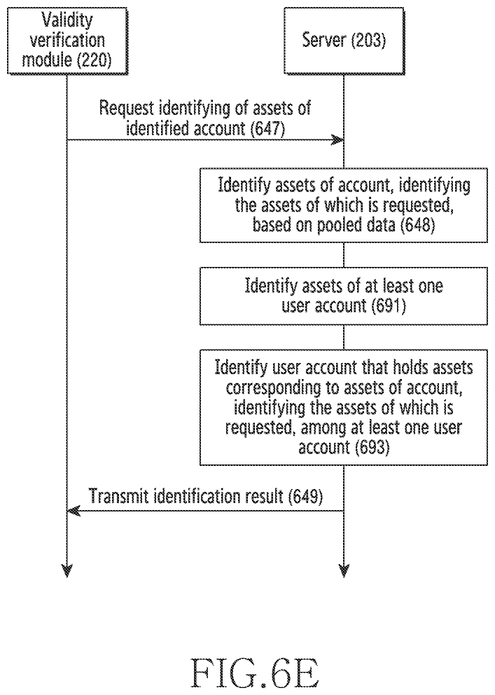

FIG. 6A is a flowchart illustrating an operation of identifying validity of recorded data by an electronic device according to an embodiment of the disclosure.

Referring to FIG. 6A, in operation 610, the data may be recorded in the memory 130 by an electronic device (e.g., the electronic device 101 of FIG. 1 or the electronic device 201 of FIG. 2). According to an embodiment, the data may be recorded in a predetermined area (e.g., an area corresponding to a clipboard) of the memory 130.

Referring to FIG. 6A, in operation 615, the detection module 210 may identify the data recorded in the memory 130. According to an embodiment, the detection module 210 may identify the data recorded in the predetermined area of the memory 130.

Referring to FIG. 6A, in operation 620, the detection module 210 may determine whether the identified data is provided in a predetermined format. According to an embodiment, the predetermined format may be a format including numbers, alphabet, or a combination thereof. According to an embodiment, the predetermined format may at least include the format of an account used in a decentralized network (e.g., a block chain network).

In operation 620, if the identified data is data provided in the predetermined format (determined as “Yes”), the detection module 210 may proceed with operation 630. In operation 620, if the identified data is not data provided in the predetermined format (determined as “No”), the detection module 210 may proceed with operation 615 for identifying the data recorded in the memory 130.

Referring to FIG. 6A, in operation 630, the detection module 210 may transmit data provided in the predetermined format to the validity verification module 220.

Referring to FIG. 6A, in operation 640, the validity verification module 220 may identify the validity of the received data. According to an embodiment, the validity verification module 220 may identify an account from the received data, and may identify the validity of the identified account.

According to an embodiment, the validity verification module 220 may identify the block chain network 205 based on the identified account, and may identify the validity of the identified account based on an account generation algorithm (e.g., keccak256) corresponding to the identified block chain network 205.

According to an embodiment, the validity verification module 220 may identify the block chain network 205 based on the identified account, and may request inquiring about the identified account from the block chain network 205. According to an embodiment, the validity verification module 220 may identify the validity of the identified account based on an inquiry result from the block chain network 205.

According to an embodiment, the validity verification module 220 may request the server 203 to identify assets associated with the identified account. According to an embodiment, the validity verification module 220 may identify the validity of the identified account based on an asset identification result from the server 203.

Referring to FIG. 6A, in operation 650, the validity verification module 220 may determine whether the received data is valid data. According to an embodiment, if the data is identified as being valid in operation 640, the validity verification module 220 may determine that the received data is valid data. According to an embodiment, if the data is identified as being invalid in operation 640, the validity verification module 220 may determine that the received data is invalid data.

In operation 650, if the received data is valid data (determined as “Yes”), the validity verification module 220 may proceed with operation 660. In operation 650, if the received data is invalid data (determined as “No”), the validity verification module 220 may terminate operation of FIG. 6A.

Referring to FIG. 6A, in operation 660, the validity verification module 220 may broadcast data including a parameter. According to an embodiment, the data including the predetermined parameter may be messaging data (e.g., intent).

According to an embodiment, the predetermined parameter may be an execution condition for at least one of applications. According to an embodiment, the predetermined parameter may include information executable from the data recorded in the memory 130 (e.g., information associated with a block chain network, an account, a symbol (e.g., ETH), a transaction amount (e.g., a remittance), a transaction item, or a combination thereof).

FIG. 6B is a flowchart illustrating an operation of statically identifying validity of recorded data by an electronic device according to an embodiment of the disclosure. Operations shown in FIG. 6B may be included in operation 640 of FIG. 6A.

Referring to FIG. 6B, in operation 641, the validity verification module 220 may identify an account from the received data, the data recorded by an electronic device (e.g., the electronic device 101 of FIG. 1 or the electronic device 201 of FIG. 2). Referring to FIG. 6B, in operation 642, the validity verification module 220 may identify a block chain network corresponding to the identified account. Although operations 641 and 642 are illustrated as separate operations in FIG. 6B, operations 641 and 642 may be performed as a single operation at the same time.

According to an embodiment, the validity verification module 220 may identify a block chain service corresponding to the identified account. According to an embodiment, the validity verification module 220 may identify an account based on 40-digit hexadecimal data that begins with “0x”, and may identify Ethereum corresponding to the identified account. According to an embodiment, the validity verification module 220 may identify an account based on 26-byte to 35-byte hexadecimal data that begins with “1” or “3”, and may identify Bit Coin corresponding to the identified account. According to an embodiment, the validity verification module 220 may identify an account based on data, which includes “bitcoincash” as a prefix, uses “,” as a delimiter, begins with “q” or “p”, and includes hexadecimal data, and may identify Bitcoin Cash corresponding to the identified account.

Referring to FIG. 6B, in operation 643, the validity verification module 220 may identify the validity of the identified account based on the account generation algorithm of the identified block chain network.

FIG. 6C is a flowchart illustrating an operation of dynamically identifying validity of recorded data by an electronic device according to an embodiment of the disclosure. In FIG. 6C, the data may be recorded by an electronic device such as, for example, the electronic device 101 of FIG. 1 or the electronic device 201 of FIG. 2. Operations shown in FIG. 6C may be included in operation 640 of FIG. 6A.

Operations 641 and 642 of FIG. 6C may correspond to operations 641 and 642 of FIG. 6B.

Referring to FIG. 6C, in operation 644, the validity verification module 220 may request the identified block chain network (e.g., the block chain network 205) to inquire about the identified account.

Referring to FIG. 6, in operation 645, the block chain network 205 may identify at least one of a transaction or the balance of the account about which inquiry is requested. According to an embodiment, the block chain network 205 may identify at least one of a transaction or the balance of the account, about which inquiry is requested, from block chain data.

Referring to FIG. 6C, in operation 646, the block chain network 205 may transmit an inquiry result to the validity verification module 220. According to an embodiment, the inquiry result may be information associated with a transaction of the account, about which inquiry is requested, the balance of the account, about which inquiry is requested, or a combination thereof.

The validity verification module 220 may identify the validity of the identified account based on the inquiry result from the block chain network 205. According to an embodiment, the validity verification module 220 may identify the identified account as being valid if a transaction of the identified account is present or the balance of the identified account is present.

FIG. 6D is a flowchart illustrating an operation of identifying validity of recorded data using a server, by an electronic device according to an embodiment of the disclosure. For example, the operation may include identifying validity of recorded data using the server 203, by an electronic device (e.g., the electronic device 101 of FIG. 1 or the electronic device 201 of FIG. 2). Operations 641, 642, and 647 to 649 among operations shown in FIG. 6D may be included in operation 640 of FIG. 6A.

Referring to FIG. 6D, in operation 601, the server 203 may pool transaction data from the block chain network 205. According to an embodiment, the server 203 may observe an event log occurring at the point in time at which a block is produced in the block chain network 205. According to an embodiment, if a predetermined event log is identified, the server 203 may obtain data, indicated by the identified event log, from the block chain network 205.

Referring to FIG. 6D, in operation 603, the server 203 may store the data pooled from the block chain network 205. According to an embodiment, the server 203 may store at least a part of the block chain data pooled from the block chain network 205 separately from the block chain network 205. According to an embodiment, the server 203 may process at least the part of the block chain data pooled from the block chain network 205 to be materials in a predetermined format, and may store the same in a separate database.

Operations 641 and 642 of FIG. 6D may correspond to operations 641 and 642 of FIG. 6B.

Referring to FIG. 6D, in operation 647, the validity verification module 220 may request the server 203 to identify assets of the identified account.

Referring to FIG. 6D, in operation 648, the server 203 may identify the asset of the account, identifying the assets of which is requested, based on the pooled data. According to an embodiment, the server 203 may identify the assets of the account, identifying the assets of which is requested, using a database based on the pooled block chain data.

Referring to FIG. 6D, in operation 649, the server 203 may transmit an identification result to the validity verification module 220.

Subsequently, the validity verification module 220 may identify the validity of the identified account based on the identification result from the server 203. According to an embodiment, the validity verification module 220 may identify the identified account as being valid if the identified account holds assets or performed a transaction of the assets.

FIG. 6E is a flowchart illustrating an operation of receiving information associated with a recommended user account from a server, by an electronic device according to an embodiment of the disclosure. For example, the operation may include receiving information associated with a recommended user account from the server 203, by an electronic device (e.g., the electronic device 101 of FIG. 1 or the electronic device 201 of FIG. 2.) Operations 647 to 649 among the operations shown in FIG. 6E may correspond to operations 647 to 649 of FIG. 6D.

Referring to FIG. 6E, in operation 691, if the assets of the account, identifying the assets of which is requested, are identified, the server 203 may identify the assets of at least one user account.

Referring to FIG. 6E, in operation 693, the server 203 may identify a user account that holds assets corresponding to the assets of the account, identifying the assets of which is requested, among the at least one identified user account.

Referring to FIG. 6E, in operation 649, the server 203 may provide, to the validity verification module 220, information associated with the identified user account together with an identification result associated with the assets of the account, identifying the assets of which is requested.

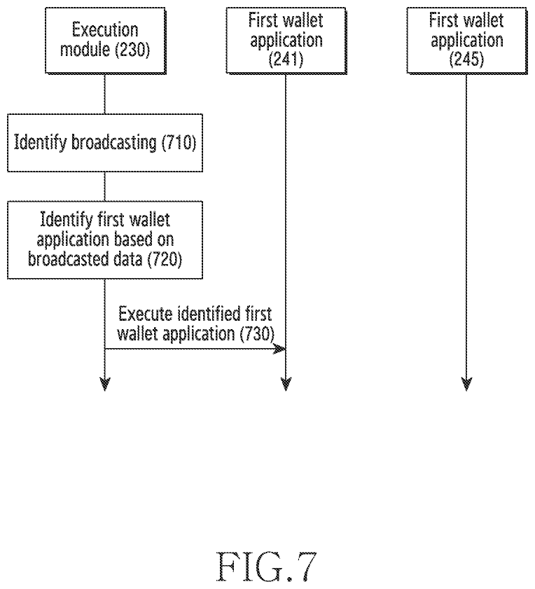

FIG. 7 is a flowchart illustrating an operation of executing a wallet application corresponding to an account included in data, by an electronic device according to an embodiment of the disclosure. For example, an operation may include executing a wallet application (e.g., the first wallet application 241) corresponding to an account included in data, by an electronic device (e.g., the electronic device 101 of FIG. 1 or the electronic device 201 of FIG. 2).

Referring to FIG. 7, in operation 710, the execution module 230 may identify broadcasting. According to an embodiment, the broadcasting may be broadcasting from the validity verification module 220 in operation 660.

Referring to FIG. 7, in operation 720, the execution module 230 may identify the first wallet application 241 based on broadcasted data. According to an embodiment, the execution module 230 may identify the first wallet application 241 that is capable of transmitting a transaction to a block chain network (e.g., Ethereum) indicated by broadcasted messaging data, among first wallet applications (e.g., the first wallet application 241 and the first wallet application 245).

Referring to FIG. 7, in operation 730, the execution module 230 may execute the identified first wallet application 241. According to an embodiment, the execution module 230 may provide information related to the first wallet application 241. According to an embodiment, the related information may include data broadcasted from the validity verification module 220, data provided from the execution module 230, data provided from the server 203, or a combination thereof. According to an embodiment, the related information may include information associated with identification information (e.g., a symbol) of the block chain network, a reception side account, a transaction amount (e.g., the amount of remittance), a transaction item, at least one transmission side account, or a combination thereof.

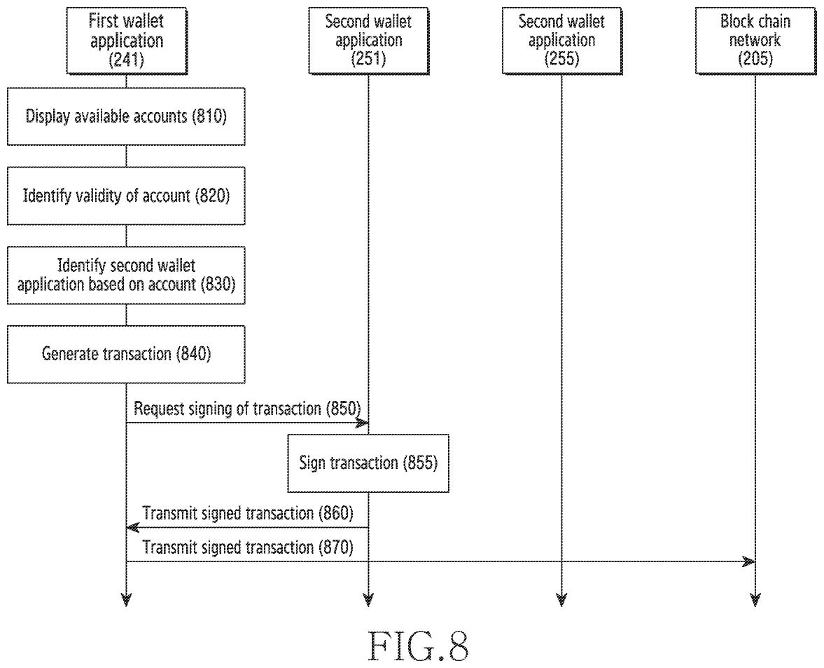

FIG. 8 is a flowchart illustrating an operation of generating a transaction by an electronic device (e.g., the electronic device 101 of FIG. 1 or the electronic device 201 of FIG. 2) according to an embodiment of the disclosure. For example, the transaction may be generated by the electronic device 101 of FIG. 1 or the electronic device 201 of FIG. 2.

Referring to FIG. 8, in operation 810, the first wallet application 241 may display available accounts. According to an embodiment, the available accounts may be user accounts. According to an embodiment, the available accounts may be accounts identified based on information received from the server 203.

Referring to FIG. 8, in operation 820, the first wallet application 241 may identify the validity of an account. According to an embodiment, the first wallet application 241 may identify the validity of a reception side account. According to an embodiment, the operation of identifying the validity of the reception side account may correspond to operation 640 of FIG. 6A.

Referring to FIG. 8, in operation 830, the first wallet application 241 may identify the second wallet application 251 based on the account. According to an embodiment, the first wallet application 241 may identify the second wallet application 251 based on the account (e.g., a reception side account, a transmission side account, or a combination thereof) among the second wallet applications (e.g., the second wallet application 251 and the second wallet application 255). According to an embodiment, the first wallet application 241 may identify the second wallet application 251 that is capable of signing a transaction in which the account is written among the second wallet application (e.g., the second wallet application 251 and the second wallet application 255). According to an embodiment, the first wallet application 241 may identify the second wallet application 251 that is capable of signing a transaction associated with a block chain network (e.g., Ethereum) among the second wallet application (e.g., the second wallet application 251 and the second wallet application 255).

Referring to FIG. 8, in operation 840, the first wallet application 241 may generate a transaction. According to an embodiment, the first wallet application 241 may generate a transaction in response to a user input for selecting one of the user accounts. According to an embodiment, the transaction may include information associated with a reception side account, information associated with a transmission side account, information associated with assets for a transaction, information associated with the address of a smart contract, or a combination thereof.

Referring to FIG. 8, in operation 850, the first wallet application 241 may request the second wallet application 251 to sign the generated transaction.

Referring to FIG. 8, in operation 855, the second wallet application 251 may sign the received transaction. According to an embodiment, the second wallet application 251 may sign the received transaction based on a private key associated with a transaction side account included in the transaction.

Referring to FIG. 8, in operation 860, the second wallet application 251 may transmit the signed transaction to the first wallet application 241.

Referring to FIG. 8, in operation 870, the first wallet application 241 may transmit the signed transaction to the block chain network 205.

Subsequently, the block chain network 205 may include the signed transaction in a new block, so as to record the same in block chain data.

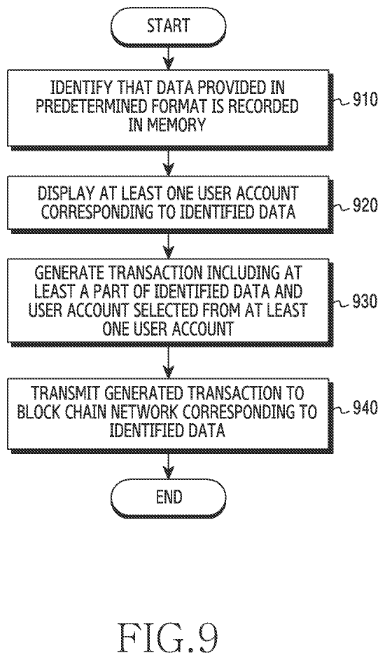

FIG. 9 is a flowchart illustrating operation of an electronic device according to an embodiment of the disclosure. For example, the operation may be of the electronic device 101 of FIG. 1 or the electronic device 201 of FIG. 2.

Referring to FIG. 9, in operation 910, the processor 120 of the electronic device 101 may identify that data in a predetermined format is recorded in the memory 130 of the electronic device 101.

Referring to FIG. 9, in operation 920, the processor 120 may display at least one user account corresponding to the identified data. According to an embodiment, the processor 120 may identify a reception side account from the identified data, and may display, on the display device 160, at least one user account corresponding to the identified reception side account.

Referring to FIG. 9, in operation 930, the processor 120 may generate a transaction including at least a part of the identified data and a user account selected from the at least one user account. According to an embodiment, the processor 120 may generate a transaction including the selected user account, based on an input for selecting one of the at least one user account. According to an embodiment, at least the part of the identified data may include a reception side account, transaction information (e.g., a symbol, a transaction amount, a transaction item, or a combination thereof), or a combination thereof.

Referring to FIG. 9, in operation 940, the processor 120 may transmit the generated transaction to the block chain network 205 corresponding to the identified data. According to an embodiment, the processor 120 may sign the generated transaction using a private key corresponding to the user account, and may transmit the signed transaction to the block chain network 205 corresponding to the identified data.

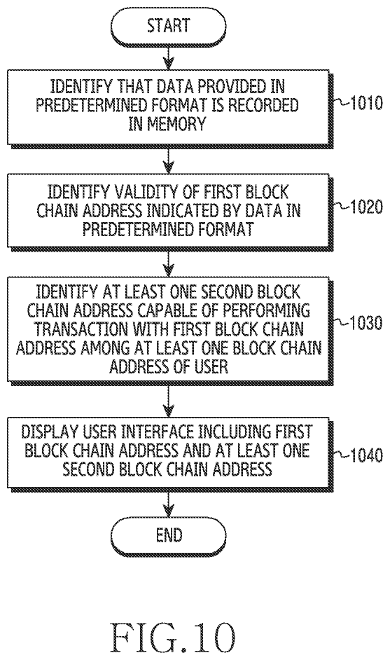

FIG. 10 is a flowchart illustrating operation of an electronic device according to an embodiment of the disclosure. The operation of the electronic device may include the operation of the electronic device 101 of FIG. 1 or the electronic device 201 of FIG. 2. According to an embodiment, operation 1010 of FIG. 10 may be included in operation 910 of FIG. 9. According to an embodiment, operations 1020 to 1040 of FIG. 10 may be included in operation 920 of FIG. 9.

Referring to FIG. 10, in operation 1010, the processor 120 of the electronic device 101 may identify that data in a predetermined format is recorded in the memory 130 of the electronic device 101.

According to an embodiment, the data provided in the predetermined format may at least include text including numbers, alphabet, or a combination thereof. According to an embodiment, the data provided in the predetermined format may include an image (e.g., quick response (QR) code or an image including text) indicating text including numbers, alphabet, or a combination thereof. According to an embodiment, the data provided in the predetermined format may include a voice signal from which text including numbers, alphabet, or a combination thereof may be extracted.

Referring to FIG. 10, in operation 1020, the processor 120 may identify the validity of a first block chain address indicated by the data provided in the predetermined format.

According to an embodiment, the processor 120 may identify the first block chain address from the data recorded in a predetermined area of the memory 130, and may identify a block chain service corresponding to the first block chain address. According to an embodiment, the processor 120 may identify the validity of the first block chain address based on an account generation algorithm (e.g., keccak256) corresponding to the identified block chain network. According to an embodiment, the processor 120 may request the identified block chain network (e.g., the block chain network 205) to inquire about the first block chain address, so as to identify the validity of the identified account. According to an embodiment, the processor 120 may request the server 203 to identify assets associated with the first block chain address, so as to identify the validity of the first block chain address.

Referring to FIG. 10, in operation 1030, the processor 120 may identify at least one second block chain address that is capable of performing a transaction with the first block chain address among at least one block chain address of a user. According to an embodiment, the processor 120 may request, from the server 203, at least one second block chain address that is capable of performing a transaction with the first block chain address, and may receive information associated with the at least one second block chain address from the server 203.

Referring to FIG. 10, in operation 1040, the processor 120 may display, on a display device (e.g., the display device 160 of FIG. 1), a user interface including the first block chain address and at least one second block chain address.

According to an embodiment, the processor 120 may generate a transaction based on an input to the displayed user interface. According to an embodiment, the processor 120 may generate a transaction including a selected second block chain address based on an input for selecting one of the at least one second block chain address in the displayed user interface. According to an embodiment, the transaction may include information associated with the first block chain address (i.e., a reception side account), transaction information (e.g., a symbol, a transaction amount, a transaction item, or a combination thereof), and the second block chain address (i.e., a transmission side account).

According to an embodiment, the processor 120 may transmit the generated transaction to the identified block chain network (e.g., the block chain network 205). According to an embodiment, the processor 120 may sign the generated transaction using a private key corresponding to the second block chain address, and may transmit the signed transaction to the identified block chain network (e.g., the block chain network 205).

The electronic device 101 according to an embodiment may include a display (e.g., the display device 160 of FIG. 1), the memory 130 storing instructions, and the processor 120 operatively connected to the display and the memory 130, and the processor 120 may be configured to execute the instructions so as to cause the electronic device 101 to: if data provided in a predetermined format is recorded in the memory 130, identify validity of a first block chain address indicated by the data; if the validity of the first block chain address is identified, identify at least one second block chain address capable of performing a transaction with the first block chain address among at least one block chain address of a user of the electronic device 101; and display, on the display, a user interface including the first block chain address and the at least one second block chain address.

According to an embodiment, the memory 130 may be the volatile memory 132, a transient storage area (e.g., RAM), a clipboard, or a combination thereof.

According to an embodiment, the processor 120 may be configured to execute the instructions so as to cause the electronic device 101 to: identify the block chain network 205 indicated by the first block chain address among a plurality of block chain networks, based on the data format; and identify the validity of the first block chain address based on the identified block chain network 205.

According to an embodiment, the processor 120 may be configured to execute the instructions so as to cause the electronic device 101 to identify the validity of the first block chain address based on a block chain address generation algorithm associated with the identified block chain network 205.

According to an embodiment, the processor 120 may be configured to execute the instructions so as to cause the electronic device 101 to: request a transaction history related to the first block chain address from the identified block chain network 205; and identify the validity of the first block chain address based on the transaction history related to the first block chain address received from the block chain network 205.

According to an embodiment, the processor 120 may be configured to execute the instructions to cause the electronic device 101 to: if the validity of the first block chain address is not identified based on the transaction history related to the first block chain address, request the server 203, which stores a transaction history related to the identified block chain network 205, to identify the validity of the first block chain address; and identify the validity of the first block chain address based on a result of the validity identification request received from the server 203.

According to an embodiment, the processor 120 may be configured to execute the instructions to cause the electronic device 101 to identify the at least one second block chain address related to the identified block chain network 205 from among the at least one block chain address of the user.

According to an embodiment, the processor 120 may be configured to execute the instructions to cause the electronic device 101 to: identify a transaction object of the first block chain address based on the transaction history related to the first block chain address; and identify the at least one second block chain address, which holds the transaction object of the first block chain address among the at least one block chain address of the user.

According to an embodiment, the processor 120 may be configured to execute the instructions to cause the electronic device 101 to display, on the display, the user interface including the at least one second block chain address in a predetermined order.

According to an embodiment, the predetermined order is an order of use of the at least one second block chain address, an order of the at least one second block chain address identified based on a transaction history related to the first block chain address, an order of the at least one second block chain address identified based on a transaction object of the first block chain address, or an order based on a combination thereof.

According to an embodiment, the processor 120 may be configured to execute the instructions so as to cause the electronic device 101 to: execute the application 146 capable of supporting a transaction with the first block chain address; generate the user interface using the executed application 146; and display the generated user interface on the display.

An operation method of the electronic device 101 according to an embodiment may include: if data provided in a predetermined format is recorded in the memory 130 of the electronic device 101, identifying validity of a first block chain address indicated by the data; identifying at least one second block chain address that is capable of performing a transaction with the first block chain address from among at least one block chain address of a user of the electronic device in response to a fact that the validity of the first block chain address is identified; and displaying a user interface including the first block chain address and the at least one second block chain address on a display (e.g., the display device 160 of FIG. 1) of the electronic device 101.

According to an embodiment, the memory 130 may be the volatile memory 132, a transient storage area (e.g., RAM), a clipboard, or a combination thereof.

According to an embodiment, the operation of identifying the validity of the first block chain address may include: identifying the block chain network 205 indicated by the first block chain address among a plurality of block chain networks, based on the data format; and identifying the validity of the first block chain address based on the identified block chain network 205.

According to an embodiment, the operation of identifying the validity of the first block chain address based on the identified block chain network 205 may include: identifying the validity of the first block chain address based on a block chain address generation algorithm associated with the identified block chain network 205.

According to an embodiment, the operation of identifying the validity of the first block chain address based on the identified block chain network 205 may include: requesting a transaction history related to the first block chain address from the identified block chain network 205; and identifying the validity of the first block chain address based on the transaction history related to the first block chain address received from the block chain network 205.

According to an embodiment, the operation of identifying of the validity of the first block chain address based on the identified block chain network 205 may include: requesting the server 203, which stores a transaction history related to the identified block chain network 205, to identify the validity of the first block chain address if the validity of the first block chain address is not identified based on the transaction history related to the first block chain address; and identifying the validity of the first block chain address based on a result of the validity identification request received from the server 203.

According to an embodiment, the operation of identifying the validity of the first block chain address based on the identified block chain network 205 may include: identifying the at least one second block chain address related to the identified block chain network 205 among the at least one block chain address of the user.

According to an embodiment, the operation of identifying the at least one second block chain address may include: identifying a transaction object of the first block chain address based on a transaction history related to the first block chain address; and identifying the at least one second block chain address, which holds the transaction object of the first block chain address among the at least one block chain address of the user.

According to an embodiment, the operation of displaying the user interface may include: displaying, on the display, the user interface including the at least one second block chain address in a predetermined order.

According to an embodiment, the predetermined order may be an order of use of the at least one second block chain address of the user, an order of the at least one second block chain address identified based on a transaction history related to the first block chain address, an order of the at least one second block chain address identified based on a transaction object of the first block chain address, or an order based on a combination thereof.

According to an embodiment, the operation of displaying the user interface may include: executing the application 146 capable of supporting a transaction with the first block chain address; generating the user interface using the executed application 146; and displaying the generated user interface.

Methods disclosed in the claims and/or methods according to various embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments of the disclosure as defined by the appended claims and/or disclosed herein.

The programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. Further, a plurality of such memories may be included in the electronic device.

In addition, the programs may be stored in an attachable storage device which may access the electronic device through communication networks such as the Internet, Intranet, Local Area Network (LAN), Wide LAN (WLAN), and Storage Area Network (SAN) or a combination thereof. Such a storage device may access the electronic device via an external port. Further, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a display;
a memory storing instructions; and
a processor operatively connected to the display and the memory,
wherein the processor executes the instructions so as to cause the electronic device to:
in response to data provided in a predetermined format being recorded in the memory, identify validity of a first block chain address indicated by the data,
in response to the validity of the first block chain address being identified, identify at least one second block chain address capable of performing a transaction with the first block chain address among at least one block chain address of a user of the electronic device, and
display, on the display, a user interface including the first block chain address and the at least one second block chain address.

2. The electronic device of claim 1, wherein the processor executes the instructions so as to further cause the electronic device to:
identify a block chain network indicated by the first block chain address among a plurality of block chain networks, based on the predetermined data format, and
identify the validity of the first block chain address based on the identified block chain network.

3. The electronic device of claim 2, wherein the processor executes the instructions so as to further cause the electronic device to identify the validity of the first block chain address based on a block chain address generation algorithm associated with the identified block chain network.

4. The electronic device of claim 2, wherein the processor executes the instructions so as to further cause the electronic device to:
request a transaction history related to the first block chain address from the identified block chain network, and
identify the validity of the first block chain address based on the transaction history related to the first block chain address received from the block chain network.

5. The electronic device of claim 4, wherein the processor executes the instructions to further cause the electronic device to:
in response to the validity of the first block chain address not being identified based on the transaction history related to the first block chain address, request a server, which stores a transaction history related to the identified block chain network, to identify the validity of the first block chain address, and
identify the validity of the first block chain address based on a result of the validity identification request received from the server.

6. The electronic device of claim 2, wherein the processor executes the instructions to further cause the electronic device to identify the at least one second block chain address related to the identified block chain network from among the at least one block chain address of the user.

7. The electronic device of claim 1, wherein the processor executes the instructions to further cause the electronic device to:
identify a transaction object of the first block chain address based on a transaction history related to the first block chain address, and
identify the at least one second block chain address, which holds the transaction object of the first block chain address, among the at least one block chain address of the user.

8. The electronic device of claim 1, wherein the processor executes the instructions to further cause the electronic device to display, on the display, the user interface including the at least one second block chain address in a predetermined order.

9. The electronic device of claim 8, wherein the predetermined order is an order of use of the at least one second block chain address of the user, an order of the at least one second block chain address identified based on a transaction history related to the first block chain address, an order of the at least one second block chain address identified based on a transaction object of the first block chain address, or an order based on a combination thereof.

10. The electronic device of claim 1, wherein the processor executes the instructions so as to further cause the electronic device to:
execute an application capable of supporting the transaction with the first block chain address,
generate the user interface using the executed application, and
display the generated user interface on the display.

11. An operation method of an electronic device, the method comprising:
in response to data provided in a predetermined format being recorded in a memory of the electronic device, identifying validity of a first block chain address indicated by the data;
identifying at least one second block chain address that is capable of performing a transaction with the first block chain address from among at least one block chain address of a user of the electronic device in response to a fact that the validity of the first block chain address is identified; and
displaying a user interface including the first block chain address and the at least one second block chain address on a display of the electronic device.

12. The method of claim 11, wherein the identifying of the validity of the first block chain address comprises:
identifying a block chain network indicated by the first block chain address among a plurality of block chain networks, based on the predetermined data format; and
identifying the validity of the first block chain address based on the identified block chain network.

13. The method of claim 12, wherein the identifying of the validity of the first block chain address based on the identified block chain network comprises:
identifying the validity of the first block chain address based on a block chain address generation algorithm associated with the identified block chain network.

14. The method of claim 12, wherein the identifying of the validity of the first block chain address based on the identified block chain network comprises:
requesting a transaction history related to the first block chain address from the identified block chain network; and
identifying the validity of the first block chain address based on the transaction history related to the first block chain address received from the block chain network.

15. The method of claim 14, wherein the identifying of the validity of the first block chain address based on the identified block chain network comprises:
requesting a server, which stores a transaction history related to the identified block chain network, to identify the validity of the first block chain address, in response to a fact that the validity of the first block chain address is not identified based on the transaction history related to the first block chain address; and
identifying the validity of the first block chain address based on a result of the validity identification request received from the server.

16. The method of claim 12, wherein the identifying of the validity of the first block chain address based on the identified block chain network comprises:
identifying the at least one second block chain address related to the identified block chain network among the at least one block chain address of the user.

17. The method of claim 11, wherein the identifying of the at least one second block chain address comprises:
identifying a transaction object of the first block chain address based on a transaction history related to the first block chain address; and
identifying the at least one second block chain address, which holds the transaction object of the first block chain address, among the at least one block chain address of the user.

18. The method of claim 11, wherein the displaying of the user interface comprises:
displaying, on the display, the user interface including the at least one second block chain address in a predetermined order.

19. The method of claim 18, wherein the predetermined order is an order of use of the at least one second block chain address of the user, an order of the at least one second block chain address identified based on a transaction history related to the first block chain address, an order of the at least one second block chain address identified based on a transaction object of the first block chain address, or an order based on a combination thereof.

20. The method of claim 11, wherein the displaying of the user interface comprises:
executing an application capable of supporting the transaction with the first block chain address;
generating the user interface using the executed application; and
displaying the generated user interface.
